(19) United States
(12) Patent Application Publication
(10) Pub. No.: US 2025/0335599 A1
(43) Pub. Date: Oct. 30, 2025

(54) ANTENNA IN EXPANSION CARD FORM FACTOR FOR EMI-FINGERPRINT CHARACTERIZATION OF COMPUTER SYSTEMS

(71) Applicant: ORACLE INTERNATIONAL CORPORATION, Redwood Shores, CA (US)

(72) Inventors: Gerard WARRENS, Gilbert, AZ (US); Robert J. B. DAVIS, Durham, NC (US); Andrew LEWIS, Litchfield, NH (US); Kenny C. GROSS, Escondido, CA (US); Guang Chao WANG, San Diego, CA (US); Alan WOOD, San Diego, CA (US); Joseph J. ERVIN, Stow, MA (US); Feng LI, La Jolla, CA (US); Daniel F. SIEVENPIPER, San Diego, CA (US)

(21) Appl. No.: 18/650,443

(22) Filed: Apr. 30, 2024

(51) Int. Cl. G06F 21/57

(52) U.S. Cl. CPC G06F 21/577; G06F 2221/034

(57) ABSTRACT

Apparatuses, systems, and other embodiments associated with a specialized antenna expansion card for EMI fingerprint characterization of target computing systems are described. In one embodiment, an antenna expansion card includes a nonconductive frame, a planar antenna printed in conductive material on a dielectric substrate and supported by the nonconductive frame, an I/O bracket affixed to the nonconductive frame, and a connector communicably coupled to the planar antenna and accessible from an exterior surface of the I/O bracket. In one embodiment, a planar antenna PCB includes a substrate conforming to dimensional specifications of an expansion card, a triangular antenna region on the substrate flanked by ground regions separated from the antenna region by gaps that progressively widen, and a connector communicably coupled to the antenna region. In one embodiment, a computer system includes a chassis, EMI-generating components, and an antenna expansion card installed within the chassis in an expansion slot.

### BACKGROUND

Computer systems such as servers and other electronic equipment may be operated with SpyChips or counterfeit components installed in them. Also, components of the computer systems may degrade over time. The presence of SpyChips, counterfeit components, or degraded components pose security and reliability concerns. In some cases, the presence of SpyChips, counterfeit components, or degraded components can be detected in a computer or other electronic system based on scans of electromagnetic interference (EMI) generated by the system. But, positioning, sensitivity, and configuration of the antenna used for an EMI scan can limit the detection effectiveness of the EMI scan.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a printed circuit board (PCB) for a specialized fingerprinting antenna associated with EMI fingerprint characterization of computing systems.

FIG. 2 illustrates multiple views of an example PCB for a specialized fingerprinting antenna associated with EMI fingerprint characterization of computing systems.

FIG. 3 illustrates a three-dimensional (3D) view showing a primary surface of an example PCB for a specialized fingerprinting antenna associated with EMI fingerprint characterization of computing systems.

FIG. 4 illustrates a 3D view showing a secondary surface of an example PCB for a specialized fingerprinting antenna associated with EMI fingerprint characterization of computing systems.

FIG. 5 illustrates an exploded 3D view of an example PCB and an example frame for attachment to the PCB that are associated with a specialized fingerprinting antenna for EMI fingerprint characterization of computing systems.

FIG. 6 illustrates a top view of a secondary (reverse) side of the frame which is associated with a specialized fingerprinting antenna for EMI fingerprint characterization of computing systems.

FIG. 7 illustrates an east edge view of the frame which is associated with a specialized fingerprinting antenna for EMI fingerprint characterization of computing systems.

FIG. 8 illustrates an east edge view of a double-width frame for installation in a double expansion slot, which is associated with a specialized fingerprinting antenna for EMI fingerprint characterization of computing systems.

FIG. 9 illustrates an exploded 3D view of the PCB seated in and attached to the frame along with an I/O bracket and associated components for attachment to the frame and PCB, which are associated with a specialized fingerprinting antenna for EMI fingerprint characterization of computing systems.

FIG. 10 illustrates a 3D front view of an expansion card assembly that is associated with a specialized fingerprinting antenna for EMI fingerprint characterization of computing systems.

FIG. 11 illustrates a 3D rear view of the expansion card assembly that is associated with a specialized fingerprinting antenna for EMI fingerprint characterization of computing systems.

FIG. 12 illustrates a perspective view of an example target computer system having an antenna expansion card 1005 installed within a chassis of the computing system, which is associated with a specialized fingerprinting antenna for EMI fingerprint characterization of computing systems.

FIG. 13 illustrates a top view 1300 of the example target computer system having the antenna expansion card installed within the chassis of the computing system, which is associated with a specialized fingerprinting antenna for EMI fingerprint characterization of computing systems.

FIG. 14 illustrates a rear (west end) view of the example target computer system having the antenna expansion card installed within the chassis of the computing system, which is associated with a specialized fingerprinting antenna for EMI fingerprint characterization of computing systems.

FIG. 15 illustrates a first plot of return loss and a second plot of voltage standing wave ratio for an example EMI fingerprinting antenna associated with EMI fingerprint characterization of computing systems.

FIG. 16 illustrates a 3D gain plot and a 2D gain plot at a frequency of 2.6 GHz for the example EMI fingerprinting antenna associated with EMI fingerprint characterization of computing systems.

FIG. 17 illustrates a 3D gain plot and a 2D gain plot at a frequency of 1.2 GHz for the example EMI fingerprinting antenna associated with EMI fingerprint characterization of computing systems.

FIG. 18 illustrates an example EMI scanning system associated with specialized antenna for EMI fingerprint characterization of computing systems. The EMI scanning system includes a computing system configured with the example systems and/or methods disclosed.

### DETAILED DESCRIPTION

Systems, methods, and other embodiments are described herein that provide a specialized antenna for electromagnetic interference (EMI) fingerprint characterization of computing systems. In one embodiment, a fingerprinting antenna is provided in the form of an expansion card for installation in an expansion card slot of a computer system. In one embodiment, the fingerprinting antenna is a triangular monopole antenna configured to sense broadband radiofrequency emissions. In one embodiment, the fingerprinting antenna is physically installable within the chassis of the computer system, but remains external to and/or isolated from the computing functionality of the computer system.

Previous antennae for EMI scanning of computing systems suffered from a number of disadvantages. General purpose antennae can have response patterns unsuitable for coverage of the EMI environment within the chassis of the target computer being scanned. Hand-held antennae lack repeatability of positioning and require physical manipulation (e.g., opening the chassis) of the target computer to perform a scan. Each of these disadvantages introduces variability or uncertainty into EMI scan results, limiting the accuracy of EMI fingerprint analyses.

In one embodiment, a fingerprinting antenna is constructed in the form of an expansion card resolves these and other challenges. In one embodiment, the fingerprinting antenna includes an antenna traced on a printed circuit board (PCB). The fingerprinting antenna includes a nonconductive frame configured to mechanically register on an expansion connector in an expansion slot of the target computer and support the antenna PCB within the expansion slot. The fingerprinting antenna may be installed for EMI surveillance within the chassis of the target computer. EMI sensed by the fingerprinting antenna is passed to the outside of the chassis through a radiofrequency connector.

In one embodiment, the fingerprinting antenna is used for performing an EMI scanning method. A target computer having a fingerprinting antenna installed is run in a test pattern, and the fingerprinting antenna senses the EMI produced by the EMI given off by the target computer. Readings of the EMI are taken, and analyzed to determine whether the EMI indicates a problem in the target computer. If a problem (such as a spychip, a counterfeit component, or a failing component) is detected, an electronic alert will be generated.

In one embodiment, another computing system configured as an EMI fingerprint scanner to receive the EMI from the fingerprinting antenna through a radio receiver and then perform the EMI fingerprinting analyses of the target computer based on the EMI sensed by the fingerprinting antenna inside the chassis of the target computer. In one embodiment, the EMI fingerprint scanner may be configured to receive EMI from a plurality of fingerprinting antennae installed within the discrete chassis of a plurality of target computers, and to perform EMI fingerprinting analyses of the plurality of target computers while the plurality of target computers remain in-situ.

### Definitions

As used herein in reference to a device (such as a computing device or other electronic device), the term “target” indicates that the device is a subject of observation by a fingerprinting antenna.

As used herein with reference to PCBs and expansion cards, cardinal compass directions are used to refer to various edges of a PCB or expansion card. In this convention: (i) a first edge of the PCB/card configured for access by I/O connections (such as RF connector 120) to the exterior of a computer chassis may be referred to herein as a “west” edge (or alternatively, an “outer” or “exterior-facing” edge); (ii) a second edge of the PCB/card that is configured to be most proximate to an edge connector for interfacing with a motherboard may be referred to herein as a “south” edge (or alternatively, a “lower” or “board-facing” edge); (iii) a third edge of the PCB/card that is configured to be opposite to the edge connector for interfacing with the motherboard may be referred to herein as a “north” edge (or alternatively, an “upper” edge); and (iv) a fourth edge of the PCB/card that is configured to be opposite the to the I/O connections, for example the edge that extends furthest into the interior of the chassis, may be referred to herein as an “east” edge (or, alternatively, an “interior-facing” or “free” edge).

As used herein with reference to PCBs, expansion cards, and computer chassis, the terms “lateral” and “laterally” refer to position or movement from side to side of a long axis of an expansion slot, expansion card, or side to side of primary to secondary surfaces of a PCB.

As used herein, the term “substantially” with reference to parallel, perpendicular, or other orientations refers to an approximation of the stated orientation within given manufacturing tolerances, for example tolerances applicable or acceptable in devices for installation in expansion slots of a computer.

As used herein, the term “communicably coupled” refers to a connection or interface between two components that enables data or signals to pass between or through each other.

### —Example PCB Fingerprinting Antenna—

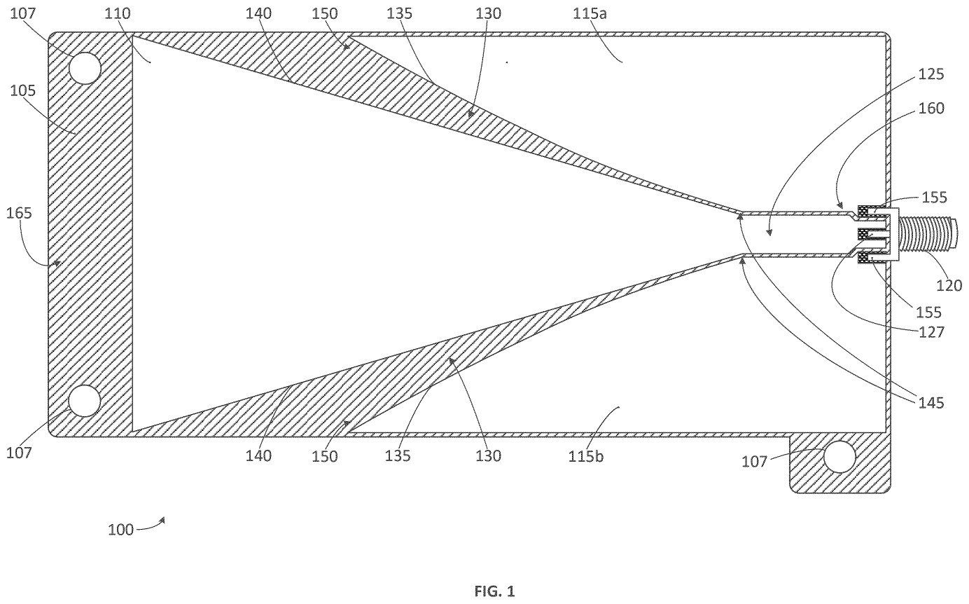

FIG. 1 illustrates one embodiment of a printed circuit board (PCB) 100 for a specialized fingerprinting antenna associated with EMI fingerprint characterization of computing systems. In one embodiment, PCB 100 includes a substrate 105, an antenna region 110, ground region(s) 115, and a connector such as a radiofrequency (RF) connector 120. In one embodiment, PCB 100 is a planar monopole antenna that is configured to gather broadband radiofrequency emissions, for example from within an interior of a chassis of a computer system.

Substrate 105 conforms to dimensional specifications of an expansion card for a computer system. In other words, substrate 105 has external dimensions (of length, height, and thickness) that do not exceed a dimensional envelope allotted to an expansion card, such as a card electromechanical volume (CEM). In one embodiment, the dimensions of substrate 105 further has external dimensions that do not cumulatively exceed the allotted envelope when combined with a support frame (as described in further detail herein below, for example, support frame 505). The particular dimensional specifications of substrate 105 depend on a type of expansion card, as discussed in further detail below. For example, in one embodiment, the substrate 105 has dimensions that fall within the dimensional envelope allotted for a low-profile peripheral component interconnect express (PCIe) expansion card. For example, from north edge to south edge (including edge fingers), the substrate 105 and support frame are within 68.9 mm. From west edge to east edge, the substrate 105 and support frame are within 167.65 mm for a half-length PCIe card, 254.00 mm for a three-quarter length PCIe card, and 312.00 mm for a full length PCIe card. In this way, the substrate 105 conforms to dimensional specifications of a low-profile PCIe expansion card.

In one embodiment, substrate 105 includes one or more mounting holes 107 for connecting PCB 100 to a frame. In one embodiment, there are three mounting holes 107. The three mounting holes 107 are placed outside of the antenna structure (antenna region 110 and ground regions 115). The three mounting holes are cut through corners of PCB 100. For example, the mounting holes 107 are in northeast, southeast, and southwest corners of PCB 100. The holes accept connections to a support frame (such as support frame 505). The support frame gives a stiff structure for retaining PCB 100. In one embodiment, outside corners of PCB 100 are slightly rounded, for example with a radius between 1 and 1.5 mm, such as 1.25 mm.

Substrate 105 is an electrically insulating (that is, dielectric) substrate. In one embodiment, substrate 105 is glass-reinforced epoxy laminate material that is flame resistant, such as FR-4. In general, a substrate having a dielectric constant (E) below 5 is acceptable. FR-4, for example, has a dielectric constant (E) between 3.9 and 4.7, for example, 4.5 (at 1 GHz). In one embodiment, the substrate may be polyimide material, which has dielectric constant (E) between 3.3 and 3.8. In one embodiment, the substrate may be polytetrafluoroethylene (PTFE) material, which has a dielectric constant between 2.0 and 2.1. The low dielectric constant reduces interference by the substrate 105 with antenna response on a secondary side of the substrate for an antenna printed on a primary face of the substrate.

Antenna region 110 is a region of conductive trace disposed on substrate 105. Antenna region 110 is substantially triangular. An antenna region is substantially triangular where it widens from a narrow end to a wide end. Substantial triangularity can be indicated by overlap of edges of the antenna region with a triangle. For example, antenna region 110 is substantially triangular because at least three edges of antenna region 110 are congruent with edges of a triangle. Or, where edges of an antenna region are not linear, substantial triangularity can be indicated where at least three edges of antenna region 110 approximately follow edges of a triangle. In one embodiment, antenna region 110 includes a throat 125. Throat 125 is a region of conductive trace disposed on substrate 105. Throat 125 is at a narrow end of antenna region 110. Throat 125 is a part of antenna region 110. For example, throat 125 overlaps and merges with a westmost point of a triangle defined by outer edges of antenna region 110. A signal contact 127 of RF connector 120 is electrically (conductively) connected to antenna region 110 at throat 125. This connection of signal contact 127 may also be referred to as a feed point of the antenna. The feed point connection of signal contact 127 may be, for example, at a westmost end of throat 125 opposite to where throat 125 merges into the triangle of antenna region 110.

Ground regions 115 are regions of conductive trace disposed on substrate 105. In one embodiment there are a plurality of ground regions 115. For example, PCB 100 may include a pair of ground regions 115, including north (or upper) ground region 115a and south (or lower) ground region 115b. Ground regions 115 flank antenna region 110 on opposite sides of antenna region 110. For example, north ground region 115a is disposed on substrate 105 above a first, upper side of antenna region 110, and south ground region 115b is disposed on substrate 105 below a second, lower side of antenna region 110. In one embodiment, there is one ground region, for example disposed on one side or another of antenna region 110.

There are gaps 130 in the conductive trace material between ground regions 115 and antenna region 110. North ground region 115a and south ground region 115b are separated from each other by antenna region 110, and by gaps 130 around antenna region 110. Gaps 130 progressively widen from west to east along PCB 100. In other words, gaps 130 progressively taper from east to west along PCB 100.

In one embodiment, gaps 130 progressively widen by a curvature of inner edges 135 of ground regions 115 away from straight outer edges 140 of the triangular antenna region 110. For example, the curvature of inner edges 135 may be a spline curve. In one embodiment, at a westmost, narrowest taper 145 of the gaps 130, the spline curves are approximately parallel with the outer edges 140 of the triangular antenna region 110. At an eastmost, widest taper 150 of the gaps 130 where the inner edges 135 of ground regions 115 terminate near the edge of substrate 105, the spline curves are at an acute angle of approximately 10 to 20 degrees (for example, 16 degrees) from parallel with the outer edges 140 of the triangular antenna region. In one embodiment, the spline curves are three-point piecewise cubic splines with natural end conditions. Thus, in one embodiment, the spline curve is defined by a plurality of cubic function segments, each interpolated through three points. Because the cubic function segments have “natural” or “free” end conditions—meaning that the cubic function “flattens out” at endpoints and has a first derivative of zero—the cubic function segments transition smoothly into adjacent segments without abrupt changes in slope. Curves other than splines may also be used, such as exponential curves, arcs (circular sections), and other curves that move away from a line that is parallel to the curve at an initial point.

The conductive trace is a sheet, layer, lead, or path of electrically transmissive material. The conductive trace material is laminated onto or otherwise affixed to the surface of the substrate 105, forming antenna region 110 and ground regions 115. In one embodiment, the conductive trace material is copper foil. Other conductive materials, including aluminum, silver, gold, and various alloys of copper can also be appropriate for forming the conductive trace of antenna region 110 and ground regions 115.

In one embodiment, the antenna region 110 of conductive trace and ground regions 115 of conductive trace are coated with a corrosion-resistant conductive coating, which may also be referred to herein as an oxidation-resistant conductive coating. The corrosion-resistant conductive coating prevents corrosion and/or oxidation from changing the electrical properties of the antenna with regard to radiofrequency reception. In one embodiment, the conductive trace is plated with gold or palladium. Thus, in one embodiment, the antenna region 110 and ground regions 115 are formed of gold (or palladium)-coated copper. In one embodiment, the traces are coated with gold, for example using the ENIG (Electroless Nickel Immersion Gold) process. In one embodiment, the traces are coated with palladium, for example using the ENEPIG (Electroless Nickel Electroless Palladium Immersion Gold) or ENEPEG (Electroless Nickel Electroless Palladium Electroless Gold) processes. Other conductive, oxidation/corrosion resistant materials may also be used as an oxidation and corrosion resistant layer on the conductive trace, including nickel, tin, and silver, although these other materials may have less resistance to oxidation over time in the absence of a conformal coating.

In one embodiment, the printed circuit board 100 is uncoated by non-conductive materials. That is, the conductive antenna region 110 and ground regions 115 lack a conformal coating on their exterior surfaces. Conformal coatings are generally a layer of polymer film, lacquer, or other non-conductive film covering the conductive trace and/or substrate. Conformal coatings provide some resistance to oxidation and corrosion of the and the consequent change in electrical properties of the antenna. In general, oxidation and corrosion-resistant metal (e.g., gold) plating of the conductive layers provides superior resistance to change in the electrical properties of the antenna in comparison with conformal coating. The radiofrequency characteristics of some conformal coatings can change over time due to aging, environmental exposure, temperature cycling, moisture, vibration, or other degradation factors. And, the radiofrequency characteristics of some conformal coatings may be inconsistent due to variations in curing, uneven application, or contamination. In one embodiment, conformal coating may be applied to printed circuit board 100 over the conductive trace and/or substrate. In one embodiment, where conformal coating is applied, the conformal coating is selected from among those that are considered transparent to RF signals, such as acrylic coatings, parylene coatings, and some silicone or urethane coatings.

In one embodiment, the oxidation and corrosion-resistant layer is chosen so as to cause the antenna to retain its electrical/radiofrequency characteristics indefinitely. This helps ensure accuracy and consistency in EMI scan readings. In one embodiment, the antenna is constructed to last for at least the design lifetime of a target computer in which it is installed, for example, 5 to 10 years, or even 20 years.

In one embodiment, an additional area 165 of substrate 105 at the east end of PCB 100 is reserved for silkscreen and part number stickers. Additional area 165 is not coated with conductive trace material. In one embodiment, additional area 165 is coated with solder mask. Lack of conductive trace material and presence of solder mask in additional area 165 prevents unintentional influence of conductive material on the electrical characteristics of the antenna.

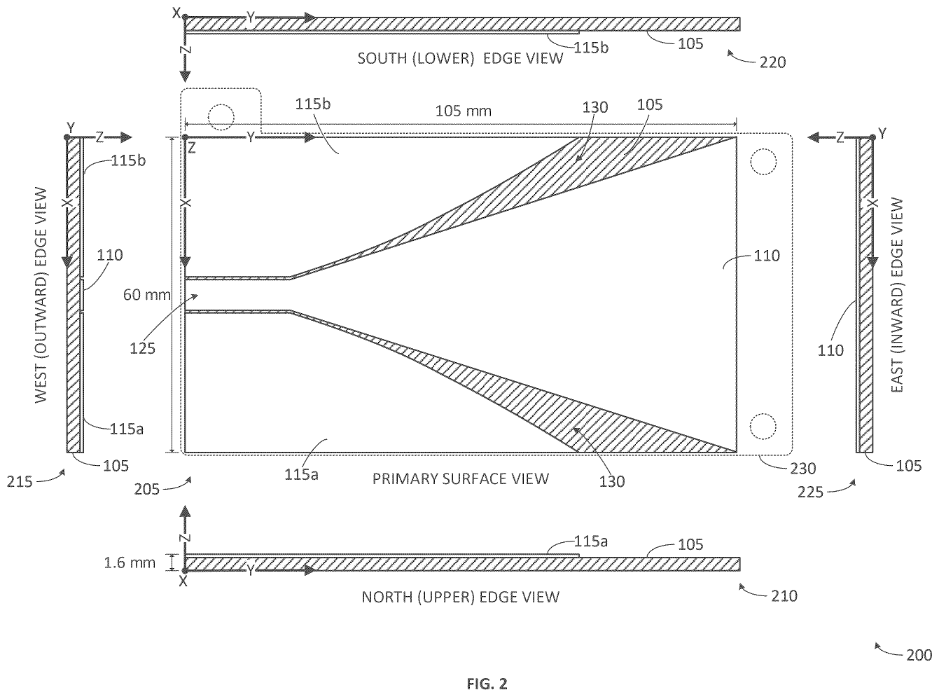

Referring briefly to FIG. 2, FIG. 2 illustrates multiple views of an example PCB 200 for a specialized fingerprinting antenna associated with EMI fingerprint characterization of computing systems. The views include a view of primary surface 205, a view of north (upper) edge 210, a view of west (outward) edge 215, a view of south (lower) edge 220, and a view of east (inward) edge 225. The view of primary surface 205 shows circuit trace (including antenna region 110 and ground regions 115) disposed on substrate 105. In one embodiment, a secondary surface (not shown) is blank and free of circuit trace. Substrate 105 may extend beyond the area occupied by trace to an outer boundary 230. Outer boundary 230 conforms to dimensional specifications of an expansion card.

Example PCB 200 conforms to dimensional specifications of a low-profile PCIe expansion card. The height of the region occupied by trace in example PCB 200 is 60 mm (or less): in one embodiment, the vertical height of the antenna region 110 at its tallest (and from upper and lower edges of ground regions 115) is 56 mm. This leaves a 2 mm border (or “keep-out” area) of substrate between the region of conductive trace and outer boundary 230, in accordance with the CEM allowed for a low-profile PCIe. And, the width of the region occupied by trace in example PCB 200 is 105 mm (or less). The area of trace in example PCB 200 thus remains within an area allotted to components and trace for a low-profile PCIe expansion card. In one embodiment, the overall thickness of PCB 200 is 1.6 mm, as is shown (with exaggerated thickness) in edge views 210, 215, 220, and 225. The overall thickness of PCB and trace thus remains well within a thickness available for PCB, trace, and components for a low-profile PCIe slot.

Referring again to FIG. 1, the connector is communicably coupled to the antenna region. In one embodiment, radiofrequency connector 120 includes signal contact 127 and ground contact 155. Antenna region 110 is electrically connected to signal contact 127. Ground regions 115 are electrically connected to the ground contact 155. Through ground contact 155, ground regions 115 are electrically grounded or earthed, for example by connection to an electrically conductive computer chassis that is itself grounded electrically. In one embodiment, north ground region 115a is electrically connected to south ground region 115b through ground contact 155.

In one embodiment, radiofrequency connector 120 is configured to create a separable connection between antenna region 110 and a feedline to a radio receiver. (In an alternative embodiment discussed below under the heading “Alternative On-Board Receiver Configuration”, the radio receiver is on-board PCB 100, and the connector is configured to create a separable connection between the on-board radio receiver and a data network.) In one embodiment, radiofrequency connector 120 is a coaxial connector. In a coaxial connector, signal contact 127 is connected to a signal lead which extends through a center of the connector, and ground contact 155 are connected to an outer interface (such as a threaded barrel) that surrounds and is electrically insulated from the signal lead. In one embodiment, the conductive portions of radiofrequency connector 120 are plated with gold or other oxidation and corrosion-resistant metal to preserve the electrical characteristics of radiofrequency connector 120.

In one embodiment, radiofrequency connector 120 is a SubMiniature version A connector—a type of semi-precision coaxial radiofrequency connector having a screw-type coupling mechanism. In one embodiment, radiofrequency connector 120 is a female connector. In one embodiment, radiofrequency connector 120 is a male connector. In one embodiment, radiofrequency connector 120 is a straight edge mount connector that is configured to straddle an edge of PCB 100, for example having one or more ground contacts 155 extending over both primary and secondary surfaces of PCB 100.

In one embodiment, the throat 125 of antenna region 110 is narrowed slightly to allow for soldering to surface mount connectors of radiofrequency connector 120. In one embodiment, the shapes of antenna region 110 and ground regions 115 may be adjusted to align soldering pads with signal contact 127 and ground contacts 155 of RF connector 120. For example, throat 125 of antenna region 110 may be waisted inward towards a center axis of antenna region 110, and tabs of the ground regions 115 extended inward towards the center axis, as shown at reference 160.

Other connector types may also be acceptable for use as radiofrequency connector 120. For example, suitable RF connectors may include a wide variety of coaxial connectors such as Reverse-Polarity SMA, SMB (SubMiniature version B), SMC (SubMiniature version C), Type N, F-type, RCA (Radio Corporation of America), QLS (Quick Lock Standard), QMA (Quick-Lock SMA) and QN (Quick-Lock N), BNC (Bayonet Neill-Concelman), TNC (Threaded Neill-Concelman), C-type (Concelman), DIN 1.0/2.3, DIN 4.3/10, UHF and mini-UHF, Motorola, Belling-Lee, FME (For Mobile Equipment), LEMO (or other push-pull connectors), MCX (Micro Coaxial), and MMCX (Micro-Miniature Coaxial) connectors. Suitable RF connectors may also include multi-pin connectors such as USB (universal serial bus), RJ-45, HDMI, Firewire, and a wide variety of other connectors capable of establishing an electrical connection to an electrical cable for carrying information about the EMI detected by antenna region 110.

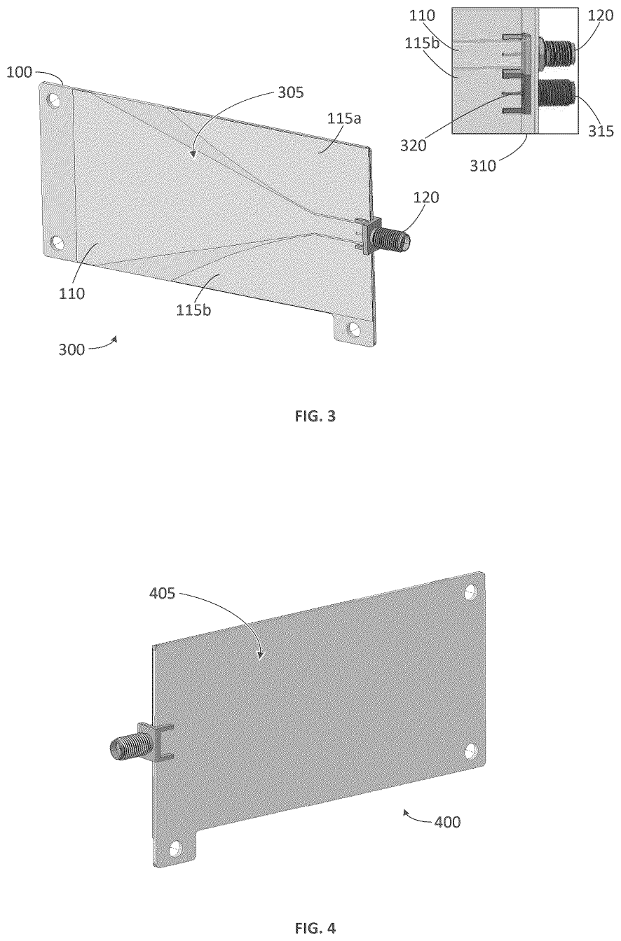

FIG. 3 illustrates a three-dimensional (3D) view 300 of PCB 100 showing a primary surface 305 of PCB 100 for a specialized fingerprinting antenna associated with EMI fingerprint characterization of computing systems. Primary surface 305 has the antenna region 110 and ground regions 115 disposed thereon, for example as shown in FIGS. 1 and 2. RF connector 120 is edge mounted such that the ground contacts connect the ground regions 115 around the antenna region 110.

In one embodiment, as shown in inset view 310, PCB 100 may include an additional radiofrequency connector 315 in addition to radiofrequency connector 120. Additional radiofrequency connector 315 provides an electrical connection for shielded output of the ground regions 115a, 115b, and chassis of a target computer via additional signal contact 320.

FIG. 4 illustrates a 3D view 400 of PCB 100 showing a secondary surface 405 of PCB 100 for a specialized fingerprinting antenna associated with EMI fingerprint characterization of computing systems. Secondary surface 405 is on the reverse of PCB 100 from primary surface 305. In one embodiment, secondary surface is left blank, and has no antenna, ground, or other conductive trace disposed thereon.

### —Selected Features of Example PCB Fingerprinting Antenna—

In one embodiment, PCB 100 is configured to be installed in an expansion slot of the computer system with the antenna region 110 and ground regions 115 oriented within an interior of a chassis of the computer system and the radio-frequency connector 120 extending to an exterior of the chassis of the computer system.

In one embodiment, PCB 100 is further assembled as a fingerprinting antenna expansion card, as described in detail below. In this assembly, PCB 100 further includes a nonconductive frame affixed to substrate 105 and an I/O bracket attached to the nonconductive frame. The nonconductive frame has a dummy edge finger that is configured to mechanically engage with an expansion connector of the computer system. The nonconductive frame includes a seating surface configured to offset the substrate 105 towards a center of a volume allotted to an expansion slot of the computer system. Radiofrequency connector 120 extends through an opening in the I/O bracket.

In one embodiment, gaps 130 progressively widen by a spline curvature of inner edges 135 of the ground regions away from outer edges 140 of the triangular antenna region 110.

In one embodiment, the antenna region 110 further comprises a throat 125 of conductive trace disposed on the substrate 105 at a narrow end of the antenna region 110. Signal contact 127 is electrically connected to the antenna region 110 at the throat 125.

In one embodiment, the connector is a radiofrequency connector 120 including at least a signal contact 127 and a ground contact 155. The antenna region 110 is electrically connected to the signal contact 127 and the ground regions 115 are electrically connected to the ground contact 155. In one embodiment, radiofrequency connector 120 is a SubMiniature version A female connector.

In one embodiment, PCB 100 is a planar monopole antenna that is configured to gather broadband radiofrequency emissions from within an interior of a chassis of a computer system.

In one embodiment, the antenna region 110 of conductive trace and the ground regions 115 of conductive trace are plated with gold or palladium.

In one embodiment, the substrate 105 has a dielectric constant of less than 5.

In one embodiment, PCB 100 is uncoated by conformal coating.

### —Alternative On-Board Receiver Configuration—

In alternative embodiment, PCB 100 further includes an on-board radio receiver and an on-board data interface. In one embodiment, the on-board radio receiver and an on-board data interface are positioned at a western end of PCB 100, beyond a western edge of the antenna region 110 and ground regions 115a, 115b. Circuit traces of on-board radio receiver and on-board data interface are printed on PCB 100. In one embodiment, on-board radio receiver includes an integrated circuit software-defined radio receiver. On-board radio receiver includes an antenna terminal and an output data bus interface. In one embodiment, on-board data interface includes an integrated circuit data interface. On-board data interface includes an input data bus interface and output port (such as an ethernet or USB port). Circuit traces include a trace connecting throat 125 of antenna region 110 to the antenna terminal of the on-board radio receiver, data bus traces connecting output data bus interface of radio receiver to input data bus interface of data interface, and output port traces connecting output port to an output connector or jack.

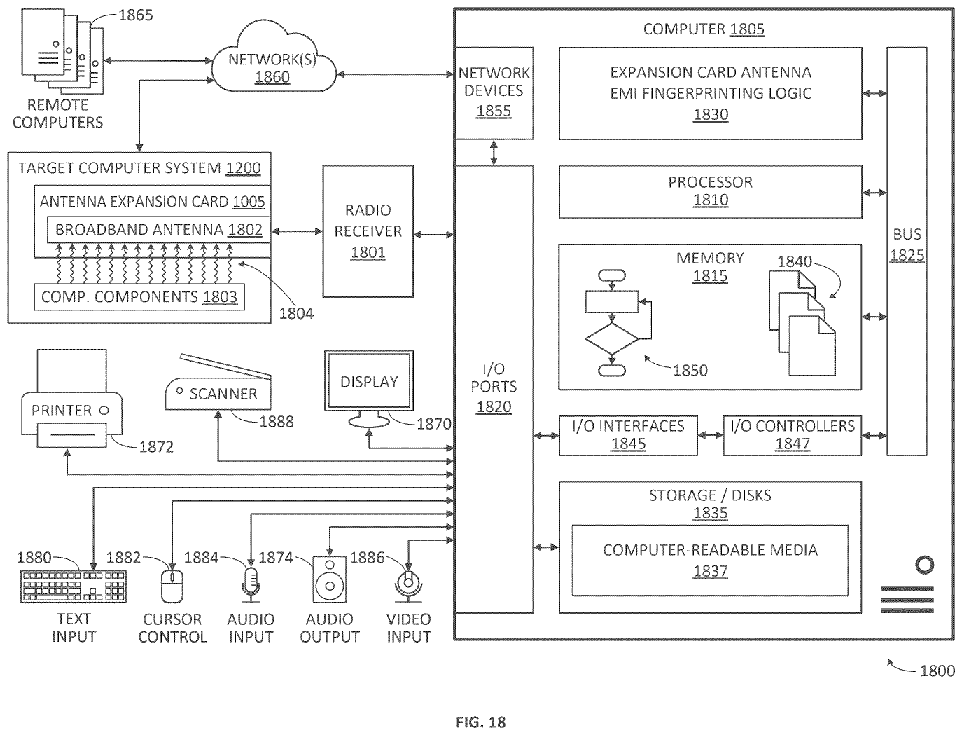

In one embodiment, EMI signals captured by antenna 110 are configured to be fed into an antenna terminal of on-board radio receiver. On-board radio receiver is configured to accept EMI signals captured by antenna 110 for processing. On-board radio receiver is configured to generate a series of digital amplitude readings (separated by a sampling interval) of the analog EMI signals sensed by antenna 110; and to transmit the digital amplitude readings through the data bus to the on-board data interface. The on-board data interface is configured to format the amplitude readings to a data structure suitable for transmission over a chosen communication protocol, such as JSON, XML, or binary; to divide the amplitude readings into packets or frames for transmission; and to transmit the packets through the output port to the output connector. From the output connector, a wired or wireless data connection transfers the amplitude readings to another computer that is configured to perform EMI scanning analyses of the amplitude readings, such as computer 1805 described with reference to FIG. 18 below.

In one embodiment, the on-board data interface is a network adapter, such as a wired or wireless ethernet adapter. In one embodiment, the on-board data interface is a universal serial bus (USB) interface. In the “on-board” configuration, radiofrequency connector 120 is replaced by a data connector, such as an ethernet jack, USB port, or a wireless ethernet antenna (although, in one embodiment, the wireless ethernet antenna itself may be connected to the data interface by a radiofrequency connector). In one embodiment, where the data interface is a USB interface, a USB wired or wireless ethernet dongle may be attached to provide the data connection through an ethernet network. Additional detail regarding the on-board radio receiver is described below with reference to radio receiver 1801 of FIG. 18. Thus, in one embodiment, the connector may be communicably coupled (that is, electrically connected) to the planar antenna either directly through signal lead (as discussed in depth above), or in one embodiment through additional processing circuits of the on-board radio receiver and on-board data interface. In either case, the connector is accessible from an exterior surface of an antenna expansion card assembly.

In one embodiment, the radio receiver and data interface may draw power from outside of target computer system 1200, for example through an outward-facing power supply port on west edge of PCB 100. In one embodiment, the radio receiver and data interface may draw power from outside of target computer system 1200, for example from power pins of an expansion connector or from a power connector on the motherboard.

Note, where the radio receiver and/or data interface are included on PCB 100, the operations of these on-board components may introduce their own EMI into the sensed environment. The introduced EMI may undesirably obscure EMI readings from sources associated with the target computer system, potentially somewhat reducing EMI fingerprint accuracy. The introduced EMI may be reduced by shielding the on-board components. While the inclusion of radio receiver and/or data interface on PCB 100 may be acceptable, in general, better performance may be obtained where the radio receiver (and associated data interface) are remote from the PCB 100, and connected to antenna 110 through radiofrequency connector 120.

### —Example Fingerprinting Antenna Expansion Card—

In one embodiment, the fingerprinting antenna of PCB 100 is incorporated into an expansion card assembly for installation into an expansion slot of a target computing system. The expansion card includes a nonconductive frame, a planar antenna supported by the nonconductive frame, an I/O bracket affixed to the nonconductive frame, and a radiofrequency connector to the antenna that is accessible from an exterior surface of the I/O bracket. As discussed above, the planar antenna is printed in conductive material on a dielectric substrate, and is electrically connected to the radiofrequency connector.

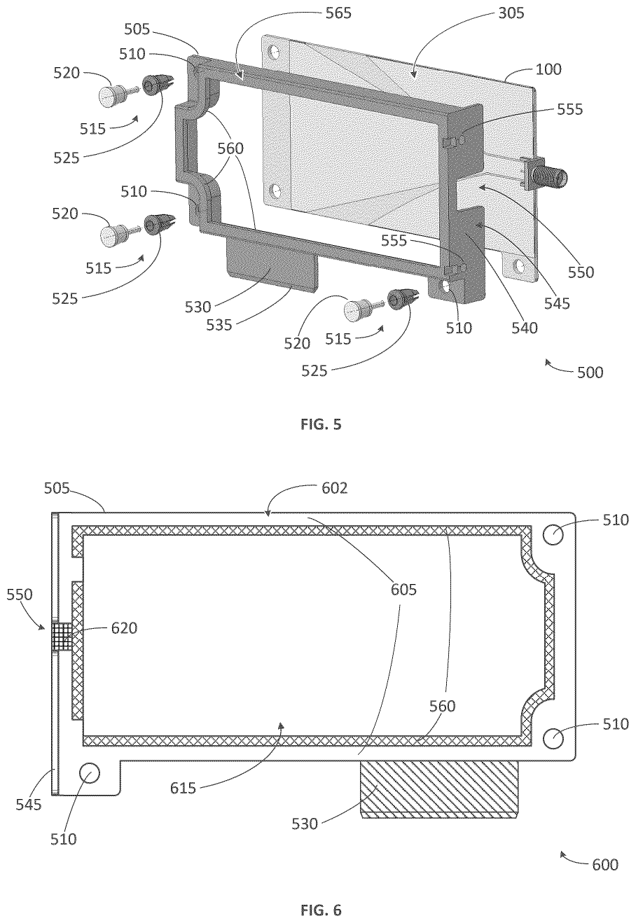

FIG. 5 illustrates an exploded 3D view 500 of PCB 100 and an example frame 505 for attachment to PCB 100 that are associated with a specialized fingerprinting antenna for EMI fingerprint characterization of computing systems. Frame 505 is made of nonconductive material to form a nonconductive frame. Frame 505 is affixed to PCB 100. Frame 505 gives a stiff structure to an expansion card form of the EMI fingerprinting antenna. Frame 505 also allows precise and repeatable location of the antenna within an expansion slot volume, for example by mechanically registering an expansion connector of the expansion slot. Frame 505 provides structural rigidity and reduces displacement of the antenna within a target computer system due to shock or vibration during system shipment or operation.

Like PCB 100, the frame 505 (and therefore, the expansion card assembly) has a form factor that conforms to dimensional specifications of an expansion card, and remains within a volume allotted to the expansion card. For example, The expansion card may have a form factor confirming to dimensional specifications of a low-profile PCIe expansion card.

In one embodiment, frame 505 is attached to primary surface 305 of PCB 100 (as shown). In one embodiment, non-conductive frame 505 is attached to secondary surface 405 of PCB 100 (not shown). Frame 505 has holes 510 that align with holes 107. For example, holes 510 are congruent with holes 107 so as to coincide when nonconductive frame 505 when frame 505 is superimposed on PCB 100. Thus, there are pairs of holes that align with each other—one hole 510 in frame 505 and one hole 170 in PCB 100—in corresponding corners of the frame 505 and PCB.

In one embodiment, push-pin rivets 515 are provided for mechanically joining frame 505 and PCB 100 together. Push-pin rivets 515 are installed though the aligned pairs of holes to affix the PCB 100 (in other words, the planar antenna) to the nonconductive frame 505. Push-pin rivets 515 include two parts, a pin 520 and an expanding sheath 525. To secure frame 505 to PCB 100, frame 505 is placed against PCB 100 with corresponding holes aligned. Expanding sheath 525 is inserted through hole 510 in frame 505 and corresponding aligned hole 170 in PCB 100, and pin 520 is inserted into expanding sheath 525. Insertion of pin 520 into expanding sheath 525 forces expanding sheath 525 outward to engage with holes 510 and 170, forming a friction fit between rivet 515 and the surrounding holes 510 and 170.

In one embodiment, bolts placed through holes 510 and 170 and nuts placed to compress frame 505 to PCB 100 may be used to join frame 505 to PCB 100. In one embodiment, screws that compress frame 505 to PCB 100 may be used to join frame 505 to PCB 100. In one embodiment, PCB 100 may be snap fit to frame 505, for example using retention hooks extending from the frame 505 to engage with edges of PCB 100. In one embodiment, frame 505 and PCB 100 may be bonded together using an adhesive. A wide variety of other means may also be suitable for join frame 505 to PCB 100.

Nonconductive frame 505 (and push-pin rivets 515) may be made of plastic. For example, polycarbonate (PC) and poly-methyl methacrylate (PMMA or acrylic) may each be suitable plastics for frame 505 due to their relatively high transparency to radiofrequency emissions. Polyethylene terephthalate (PET) may also be used for frame 505, although it has only moderate transparency to radiofrequency emissions. Other structural plastics such as acrylonitrile butadiene styrene (ABS), polyamide (nylon), and polypropylene (PP) may also be used for frame 505, but exhibit low or no transparency to radiofrequency emissions that may limit the response or sensitivity of an EMI fingerprinting antenna. Nonconductive frame 505 may alternatively be made of glass-reinforced epoxy (fiberglass) material (such as FR-4).

Frame 505 includes an edge finger 530 extending along a south outer face of frame 505. In one embodiment, edge finger 530 is an outward tab or protrusion extending along a bottom or south wall of frame 505. Edge finger 530 extends southwards away from the south outer edge of frame 505. Edge finger 530 is configured for mechanically engaging with an expansion connector of an expansion slot. For example, edge finger 530 is physically configured to insert into or mate with the expansion connector in a manner similar to an expansion card, thereby retaining frame 505 in position using the expansion connector. The engagement of edge finger 530 with the expansion connector restrains frame 505 from being displaced to laterally to either side of a long axis of the expansion slot. Edge finger 530 is therefore configured to register the location of frame 505 off of an expansion slot. In one embodiment, edge finger 530 is nonconductive, bearing no edge finger pads or other conductive trace. Edge finger 530 may therefore be considered a “dummy” edge finger, as it is not configured for electrically engaging with the expansion connector of the expansion slot.

In one embodiment, dummy edge finger 530 conforms to the dimensional specifications of an edge finger for an expansion card. For example, edge finger 530 may have a thickness of 1.57 mm, consistent with a thickness of an edge finger for a PCB expansion card. And, edge finger 530 may have a height (extending outward from the outer face of frame 505 along the north-south axis) of 13.69 mm, consistent with a height of an edge finger of a PCB expansion card. In one embodiment, dummy edge finger 530 is configured to fit snugly into at least a portion of an expansion connector. In one embodiment, edge finger 530 may have a chamfer 535 along its southern edge (such as a chamfer of 20 degrees) to aid in insertion of edge finger 530 into an expansion connector. In one embodiment, edge finger 530 may have key cutouts or notches in the southern edge to accommodate the positions of key protrusions in the expansion connector. In one embodiment, where the expansion connector or motherboard is equipped with a retention mechanism, edge finger 530 may have cutouts (for example, along an eastern edge of edge finger 530) configured for engaging with the retention mechanism.

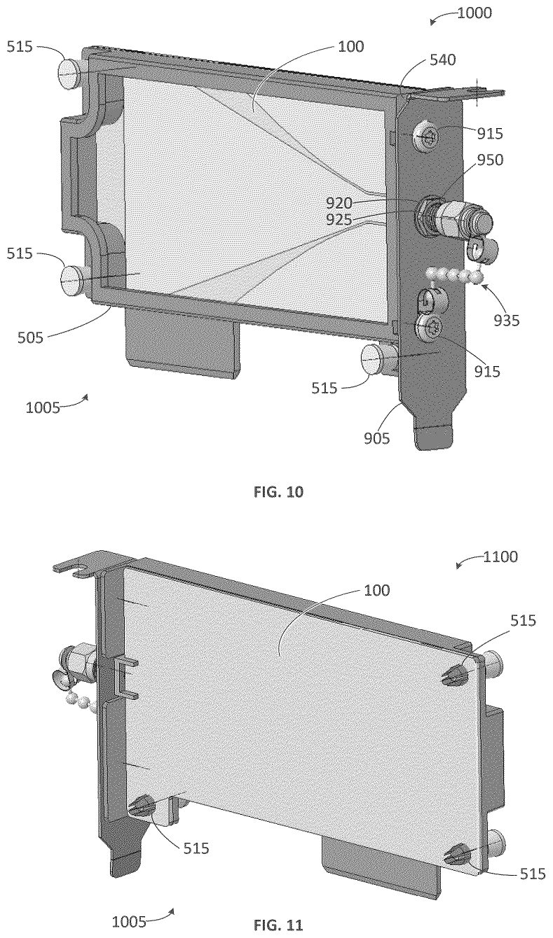

In one embodiment, frame 505 includes a vertical attachment surface 540. Attachment surface 540 is on an exterior of a west wall 545 of frame 505. Attachment surface 540 is substantially planar. West wall 545 of frame 505 includes a notch 550 (or hole) to accommodate passage of an outer profile of radiofrequency connector 120 through west wall 545 of frame 505. Attachment surface 540 is configured to abut an inward face of a vertical wall of an I/O bracket (for example as shown with reference to I/O bracket 905 in FIGS. 9 and 10). West wall 545 includes pilot holes 555 for accepting screws to attach frame 505 to the I/O bracket. West wall 545 (and other walls of frame 505) are terminated at a primary (front) side 565 of frame 505 by a stiffening flange 560. Stiffening flange 560 extends inward from the perimeter around an opening in the frame.

FIG. 6 illustrates a top view 600 of a secondary (reverse) side 602 of frame 505 which is associated with a specialized fingerprinting antenna for EMI fingerprint characterization of computing systems. The reverse side 602 of frame 505 is configured to face toward and support PCB 100 when attached. Frame 505 includes a seating surface 605. In one embodiment, frame 505 is configured to receive PCB 100 with primary surface 305 of PCB 100 oriented to face the seating surface 605. Seating surface 605 is flat, that is, substantially planar. Seating surface 605 is configured to abut PCB 100 at outside edges of PCB 100. For example, an outer border area (or perimeter area) of primary surface 305 of PCB 100 may rest upon seating surface 605. In one embodiment, an outline of seating surface 605 is substantially congruent with an outline of substrate 105 of PCB 100.

Stiffening flange 560 is set back laterally from the plane of seating surface 605. In one embodiment, stiffening flange 560 is substantially parallel to seating surface 605. The walls of frame 505 extend between seating surface 605 and stiffening flange 560, connecting stiffening flange 560 to seating surface 605. In one embodiment, stiffening flange 560 extends inward into an opening 615 of the frame. Opening 615 reduces the area of frame 500 that may block radiofrequency emissions. In one embodiment, stiffening flange 560 extends fully across opening 615 to close frame 505.

In one embodiment, west wall 545 extends outward laterally above seating surface 605. Notch 550 interrupts seating surface 605 with a recess 620 laterally below the plane of seating surface 605. Recess 620 accommodates an outer profile of radiofrequency connector 120, for example where radiofrequency connector 120 is edge mounted on substrate 105 of PCB 100 and extends above and below substrate 105.

Seating surface 605 is offset laterally from a plane of dummy edge finger 530 towards a center of a volume allocated for an expansion card. The plane of seating surface 605 is substantially parallel to the plane of dummy edge finger 530. In one embodiment, seating surface 605 is offset from the dummy edge finger 530 so as to support the conductive trace of the antenna region 110 and ground regions 115 at a center of the volume allocated for the expansion card. In one embodiment, the planes of seating surface 605, dummy edge finger 530, recess 620, and stiffening flange 560 occupy substantially parallel planes that are offset laterally from each other along a substantially perpendicular axis.

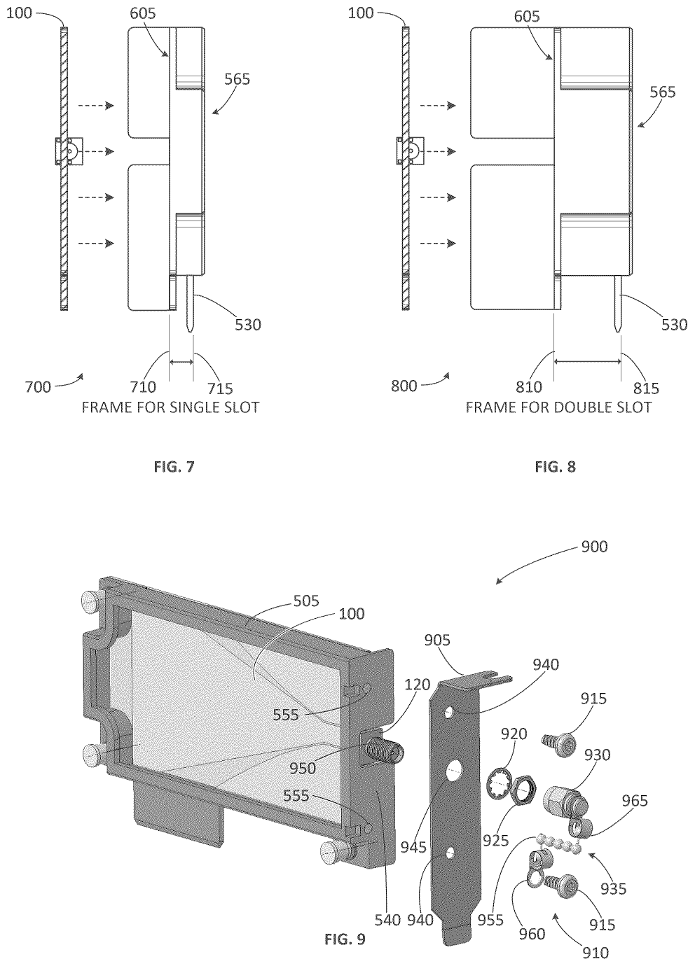

FIG. 7 illustrates an east edge view 700 of frame 505 which is associated with a specialized fingerprinting antenna for EMI fingerprint characterization of computing systems. Frame 505 is a single-width frame for installation in a single expansion slot. A first plane 710 of seating surface 605 is offset laterally from a second plane 715 of dummy edge finger 530 to a center of a volume allocated for one expansion card. In one embodiment, front side 565 may also be offset laterally from dummy edge finger 530 in an opposite direction away from a center of the volume allocated for one expansion card. When seated on seating surface 605 of frame 505, the planar antenna printed on PCB 100 is supported at a lateral middle of the CEM for a single expansion slot. When the PCB 100 and frame 505 assembly is installed in an expansion slot, the frame 505 uses dummy edge finger 530 to register the lateral position of the PCB 100 antenna off of the expansion connector of the expansion slot. In short, the long edge finger 530 at the bottom of the plastic frame 505 locates the card into the expansion (e.g., PCIe) slot connector, while keeping the antenna centered in the PCIe card volume.

FIG. 8 illustrates an east edge view 800 of a double-width frame 805 for installation in a double expansion slot (two adjacent expansion slots), which is associated with a specialized fingerprinting antenna for EMI fingerprint characterization of computing systems. A first plane 810 of seating surface 605 is offset laterally from a second plane 815 of dummy edge finger 530 to a center of a volume allocated for two expansion cards. This offset is greater than the offset in the single-width frame. However, in one embodiment, the offset of the front side 565 from dummy edge finger 530 for double-width frame 805 remains consistent with the offset of front side 565 in single width frame 505. The position of the double width frame 805 is thus indexed off of a first (rightmost, from the east view) of two expansion connectors in two adjacent expansion slots. When seated on seating surface 605 of double-width frame 805, the planar antenna printed on PCB 100 is supported at a lateral middle of the CEM for a double expansion slot. The double-width frame 805 provides additional clear volume around the planar antenna of PCB 100, which may increase the EMI readable by the antenna. Triple-width (and wider) frames may also be constructed to increase clear volume around the antenna.

FIG. 9 illustrates an exploded 3D view 900 of PCB 100 seated in and attached to frame 505 along with an I/O bracket 905 and associated components 910 for attachment to frame 505 and PCB 100, which are associated with a specialized fingerprinting antenna for EMI fingerprint characterization of computing systems. PCB 100, frame 505, and I/O bracket 905 and associated components 910 may be assembled to form a fingerprinting antenna assembly (for example as shown and described with reference to FIGS. 10 and 11). Associated components 910 include screws 915, washer 920, nut 925, cap 930, and tether 935.

In one embodiment, I/O bracket 905 is formed from conductive material, such as steel. For example, I/O bracket 905 may be a pressed steel shape that conforms to specifications for an expansion slot bracket. I/O bracket 905 includes screw holes 940 and connector hole 945 through a vertical wall of I/O bracket 905. A screw hole 940 is of sufficient diameter to allow passage of the threaded shank of screw 915, and to not allow passage of the head of screw 915. Screw holes 940 align with pilot holes 555 in attachment surface 540. Connector hole 945 is of sufficient diameter to allow passage of the threaded barrel 950 (or other outer interface) of the radiofrequency connector 120, and not to allow passage of washer 920 or nut 925.

In one embodiment, screws 915 may be self-tapping so as to cut into the plastic of frame 505 through the cylindrical walls of pilot holes 555 when screws 915 are installed. In one embodiment, the walls of pilot holes 555 may be threaded with a thread that mates with that of screws 915. In one embodiment, screws 915 are made of conductive material, such as steel. In one embodiment, screws 915 have a shank diameter of approximately 4 mm, such as a 4 mm screw or a No. 8 screw. Larger or smaller diameters may also be appropriate. In one embodiment, screws 915 are of a length that protrudes only minimally into the volume of the expansion slot when installed so as to minimize the influence of screws 915 on the RF response of the antenna. For example, screws 915 might have a shank length of less than 10 mm. Screws 915 may have a star, square, Allen, Phillips, slot, or other drive socket.

In one embodiment, washer 920 is a locking washer. In one embodiment, locking washer 920 is made of conductive material, such as brass. In one embodiment, the inner diameter of washer 920 is of sufficient diameter to allow passage of the threaded barrel 950 of radiofrequency connector 120. Nut 925 is threaded about an interior circumference to engage with and twist onto threaded barrel 950. In one embodiment, nut 925 is made of conductive material, such as brass. When assembled, locking washer 920 is compressed between an outer face of I/O bracket 905 and an inner face of nut 925 to resist loosening of nut 925. In one embodiment, nut 925 is a locking nut, and washer 920 is not used. In one embodiment, a liquid thread locker may be applied between nut 925 and threaded barrel 950 to resist loosening of nut 925.

In one embodiment, I/O bracket 905 is a low-profile bracket, for example having an overall height of approximately 79.2 mm to fill, cover, or otherwise close a low-profile connector opening in the chassis. In one embodiment, I/O bracket 905 is a standard (that is, full-height) I/O bracket, for example having an overall height of approximately 120.0 mm to fill, cover, or otherwise close a standard height connector opening in the chassis. In double- and triple-width fingerprinting antenna assemblies, I/O bracket 905 may be a two slot or three slot I/O bracket, respectively.

In one embodiment, I/O bracket 905 is affixed to frame 505 with screws 915, and also affixed to PCB 100 with locking washer 920 and nut 925. For example, an inner vertical surface of I/O bracket 905 is compressed against attachment surface 540 of frame 505 by passing the shanks of screws 905 through screw holes 940 and threading the screws into pilot holes 555. And, (SMA) radiofrequency connector 120 is mechanically held in place in connector hole 945 of I/O bracket 905 by nut 925 engaging with threaded barrel 950 and compressing washer 920 against an outer vertical surface of I/O bracket 905. In this configuration, the frame 505 and I/O bracket 905 provide rigid mechanical support for the PCB 100 antenna.

Cap 930 is a closure for radiofrequency connector 120. Cap 930 is an open circuit connector cap that is configured to cover and protect radiofrequency connector 120 (and the antenna region 110) when radiofrequency connector 120 is not connected to a feedline. Cap 930 is configured to electrically isolate the antenna region 110 from EMI external to a computer chassis when in place on radiofrequency connector 120. In one embodiment, cap 930 is configured to engage with the grounded outer interface of radiofrequency connector 120 and cover the signal lead of radiofrequency connector 120. Cap 930 is configured to be electrically insulated from the signal lead of radiofrequency connector 120, for example by an air gap. In one embodiment, cap 930 is formed of conductive material, such as brass.

In one embodiment, where the radiofrequency connector 120 has a threaded barrel 950, such as for an SMA connector, cap 930 is a concave threaded closure that is threaded about an interior circumference to engage with and twist onto threaded barrel 950. Other forms of mechanical engagement between cap and connector that are compatible with other connector types are also contemplated here, such as, for example, a snap-on engagement for affixing cap 930 to an SMB connector or a bayonet-style engagement for affixing cap 930 to a BNC connector.

When in place on radiofrequency connector, cap 930 shuts off the antenna from influencing EMI responsiveness of a computing device in which the antenna is installed. Without cap 930 (or a feedline to another system) in place on radiofrequency connector 120, for example, electrostatic discharge may infiltrate the chassis through the antenna and damage components. To protect against external EMI influence on a computing device, cap 930 is put in place on radiofrequency connector 120 when radiofrequency connector 120 is not connected to a feedline of an EMI scanning system. When cap 930 is in place, the antenna has minimal to no impact on operations of a computing device in which the antenna is installed.

To prevent loss of cap 930, and potential infiltration of external EMI into a computing device in which the antenna is installed, Cap 930 is affixed to I/O bracket 905 by a tether 935. In one embodiment, tether 935 includes a chain 955 (or other flexible harness such as a cord, lanyard, band, or strap) having an eyelet connector 960 and a cap connector 965 affixed at opposite ends of chain 955. In one embodiment, chain 955 is a beaded chain (also referred to as ball chain). Tether 935 is attached at a first end to cap 930 by cap connector 965. In one embodiment, cap connector 965 is configured to retain cap 930 and chain 955 in a rotatable connection that allows the cap to be twisted onto and off of radiofrequency connector 120. Tether 935 is attached at a second end to the exterior surface of the I/O bracket 905 by eyelet connector 960 and one of screws 915.

FIG. 10 illustrates a 3D front view 1000 of an expansion card 1005 assembly that is associated with a specialized fingerprinting antenna for EMI fingerprint characterization of computing systems. PCB 100 is seated on seating surface (not visible) of frame 505 and attached to frame 505 by push-pin rivets 515. In 3D front view 1000, a primary (printed) surface of PCB 100 faces toward the front, towards the seating surface of the frame 505. I/O bracket 905 is mechanically and conductively connected to radiofrequency connector 120 by washer 920 and nut 925 threaded snugly onto threaded barrel 950. I/O bracket 905 abuts and is attached to attachment surface 540 of frame 505 by screws 915. Cap 930 is in place and threaded onto threaded barrel 950. Cap 930 is harnessed to I/O bracket 905 by tether 935. Tether 935 is connected at one end to I/O bracket 905 by a screw 915.

FIG. 11 illustrates a 3D rear view 1100 of expansion card 1005 assembly that is associated with a specialized fingerprinting antenna for EMI fingerprint characterization of computing systems. In 3D rear view 1100, a secondary (unprinted) surface of PCB 100 faces toward the rear, away from the seating surface of the frame 505. In one embodiment, the primary (printed) surface of PCB 100 faces toward the rear of the frame 505, and the secondary (unprinted) surface of PCB 100 faces toward the front. PCB 100 is held in place against seating surface (not visible) of frame 505 and attached to frame 505 by push-pin rivets 515.

### —Selected Features of Example Fingerprinting Antenna Expansion Card—

In one embodiment, in the expansion card 1005, the nonconductive frame 505 includes a dummy edge finger 530 that is configured for mechanically engaging an expansion connector in an expansion slot of a computer system. And, the nonconductive frame 505 supports the planar antenna (e.g., PCB 100) in a location (atop seating surface 605) that is offset laterally from the dummy edge finger 530 towards a center of an electromechanical volume allotted to the expansion card by dimensional specifications.

In one embodiment, the expansion card 1005 has a form factor confirming to dimensional specifications of a low-profile PCIe expansion card.

In one embodiment, in the expansion card 1005, the dielectric substrate 105 of the planar antenna and nonconductive frame 505 further comprise holes 170, 510 in a plurality of corners. Pairs of the holes 170, 510 in corresponding corners of the dielectric substrate 105 and the nonconductive frame 505 are aligned. The expansion card 1005 also includes push-pin rivets 515 installed though the aligned pairs of holes 170, 510 to affix the planar antenna (e.g., PCB 100) to the nonconductive frame 505.

In one embodiment, where the connector is a radiofrequency connector 120 (that is electrically connected directly to antenna region 110), expansion card 1005 includes a cap 930 for the radiofrequency connector 120. A tether 935 is attached at a first end to cap 930 and at a second end to the exterior surface of the I/O bracket 905.

—Example Computer with Fingerprinting Antenna Expansion Card—

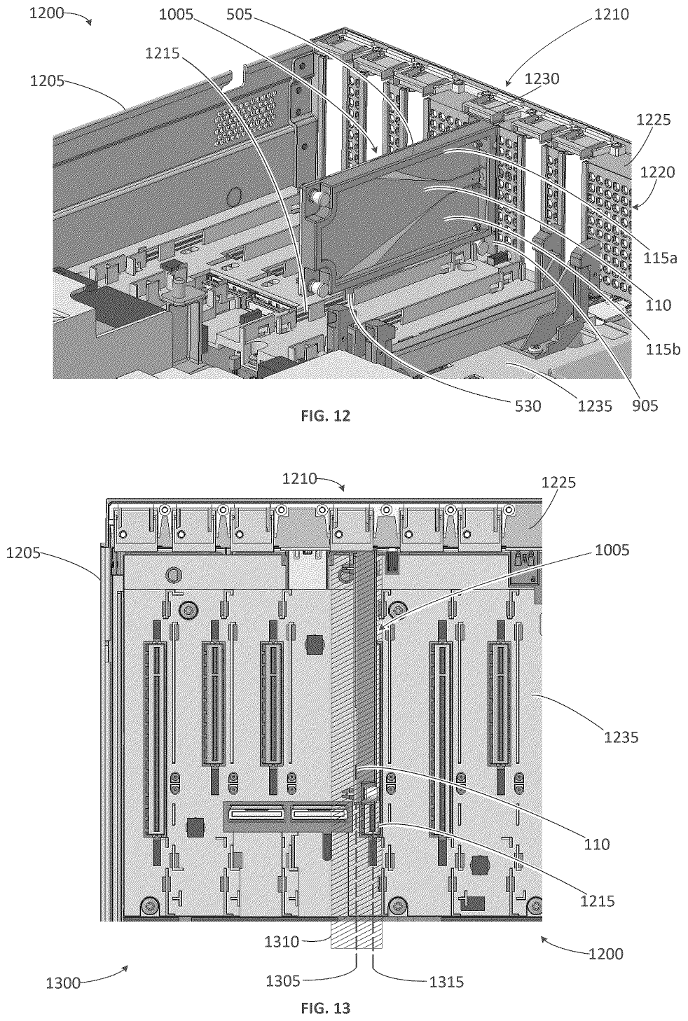

FIG. 12 illustrates a perspective view of an example target computer system 1200 having antenna expansion card 1005 installed within a chassis 1205 of the computing system 1200, which are associated with a specialized fingerprinting antenna for EMI fingerprint characterization of computing systems. In one embodiment, computer system 1200 includes chassis 1205, various computing components situated within the chassis 1205, expansion slot(s) 1210 within the chassis 1205 that include expansion connector(s) 1215, and the expansion card 1005 installed in one of the expansion card slots 1210. The computing components generate EMI when the computing components are operating. In one embodiment, PCB 100 is configured to be installed in an expansion slot of a target computer system 1200 as an antenna expansion card 1005. In the installation, frame 505 orients the antenna region 110 and ground regions 115 within an interior of a chassis of a target computer system, and the connector (such as radiofrequency connector 120) extends to an exterior of the chassis of the target computer system 1200.

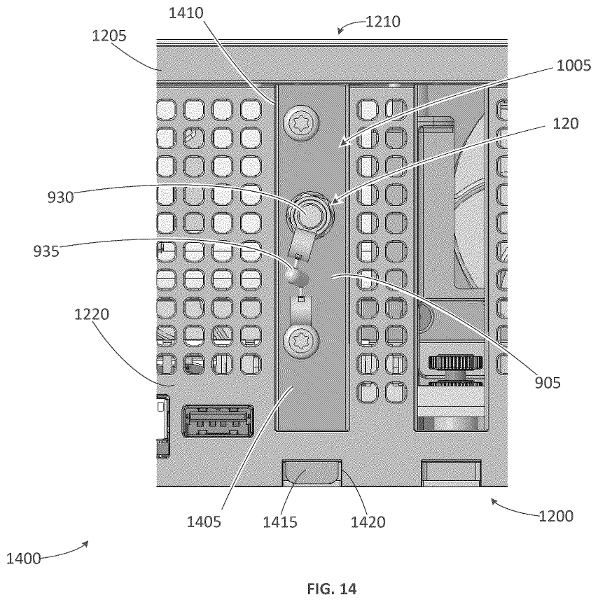

As discussed above, the antenna expansion card 1005 includes nonconductive frame 505 that has a dummy edge finger 530. Dummy edge finger 530 is configured to mechanically engage the expansion connector 1215 of the expansion slot 1210 that the expansion card 1005 is installed in. Antenna expansion card 1005 includes a broadband antenna (such as antenna region 110) printed in conductive material on a dielectric substrate (such as shown and described with reference to PCB 100). The broadband antenna 110 is held by nonconductive frame 505 at a lateral center of the expansion slot 1210 in which expansion card 1005 is installed, as shown in FIG. 13. Antenna expansion card 1005 also includes an I/O bracket 905. I/O bracket 905 is affixed to nonconductive frame 505 and to chassis 1205 of target computing system 1200. Antenna expansion card 1005 also includes a connector (such as radiofrequency connector 120), which is communicably coupled to (e.g., electrically connected to) the broadband antenna (antenna region 110). Radiofrequency connector 120 is accessible from outside the chassis 1205 on an exterior surface of I/O bracket 905, as shown in FIG. 14.

In one embodiment, antenna expansion card 1005 is installed in chassis 1205 in a particular expansion slot 1210 when a bottom or south tip of I/O bracket 905 is inserted into an I/O bracket slot (not visible, see FIG. 14) associated with the expansion slot 1205, and dummy edge finger 530 engages with an expansion connector 1215 that is associated with the expansion slot 1205. The I/O bracket slot is along a bottom edge of an I/O wall 1220 of chassis 1205, below an I/O opening (not visible, see FIG. 14) associated with the expansion slot 1210. In one embodiment, installation further includes affixing a flange at the top of I/O bracket 905 to a bracket ledge 1225, for example with a clip 1230 or screw. Mechanical engagement of the I/O bracket 905 with the chassis 1205 at the I/O bracket slot and bracket ledge 1225, and mechanical engagement of frame 505 with dummy edge finger 530 to expansion connector 1215 on a motherboard 1235 (which is affixed to chassis 1205) forms a rigid and vibrationally stable connection between antenna assembly 1005 and chassis 1205. The positioning of antenna assembly 1005 in this manner is repeatable, both for removal and reinsertion of antenna assembly 1005 in one chassis 1205, and for placement of an antenna assemblies 1005 in a known position in a plurality of chassis 1205.

Expansion connectors 1215 are configured to accept insertion of edge fingers of expansion cards. Because the expansion connectors 1215 are used to provide a mechanical indexing location for the antenna expansion card 1005, and not to communicate data, the particular type of the expansion connectors 1215 is relevant mainly for the mechanical positioning and sizing of dummy edge finger 530. In one embodiment, antenna expansion card 1005 is configured to mechanically engage one or more types of expansion connectors with dummy edge finger 530. In one embodiment, expansion connectors 1215 may include peripheral component interconnect (PCI), peripheral component interconnect express (PCIe), accelerated graphics port (AGP), industry standard architecture (ISA), and a wide variety of other standard and custom expansion interfaces. The PCIe expansion connectors may have a variety of sizes, such as PCIe x1, PCIe x2, PCIe x4, PCIe x8, PCIe x12, PCIe x16, or PCIe x32, or connectors with even higher numbers of data lanes. The PCI expansion connectors may be standard PCI or PCI-X connectors.

Antenna expansion card 1005, in one embodiment, is not in electronic communication with the computer system in which it is installed. Instead, antenna expansion card 1005 is isolated from the data operations of the target computer system. In other words, antenna expansion card 1005 is a probe that is external to the computing activities of the target computer system 1200, while being physically positioned within the chassis 1205 of the target computer system 1200. The position of antenna expansion card 1005 is in a known location that is mechanically registered off of features of the expansion slot 1210. The antenna expansion card 1005 (and the PCB-based planar broadband antenna therein) are thus “passive” components with respect to the target computer system, and do not interact with operations of the target computer system. In practical effect, because (in one embodiment) the antenna expansion card does not communicate with pins of the expansion connector, the antenna expansion card may be hot swapped—that is, inserted or removed while the target computer system is operating.

Referring now to FIG. 13, FIG. 13 illustrates a top view 1300 of example target computer system 1200 having antenna expansion card 1005 installed within a chassis 1205 of the computing system 1200, which are associated with a specialized fingerprinting antenna for EMI fingerprint characterization of computing systems. Expansion card 1005 is installed in an expansion slot 1210. As mentioned above, the broadband antenna (antenna region 110) is held at a lateral center 1305 of a volume 1310 allotted to the expansion slot 1210. In one embodiment, volume 1310 extends between a bottom or southern plane above motherboard 1235 in chassis 1205 to a top or northern plane below a top closure of chassis 1205. More particularly, expansion card 1005 holds the conductive trace that makes up antenna region 110 in a plane that is substantially parallel to and centered between sides of volume 1310. The lateral center 1305 plane of expansion slot 1210 is offset from—and substantially parallel to—a plane 1315 of a slot of an expansion connector 1215 for expansion slot 1210.

Referring now to FIG. 14, FIG. 14 illustrates a rear (west end) view 1400 of example target computer system 1200 having antenna expansion card 1005 installed within chassis 1205 of the computing system 1200, which is associated with a specialized fingerprinting antenna for EMI fingerprint characterization of computing systems. View 1400 is from an exterior of chassis 1205. Exterior surface 1405 of I/O bracket 905 is visible through I/O opening 1410 in I/O wall 1220. A bottom or south tip 1415 of I/O bracket 905 is inserted into an I/O bracket slot 1420. Tip 1415 is engaged with and retained by slot 1420. Radiofrequency connector 120 extends outward from exterior surface 1405 beyond the plane of I/O wall 1220 of chassis 1205. Radiofrequency connector 120 (as well as covering cap 930 and tether 935) are thereby rendered accessible at the exterior of chassis 1205. A feedline to an EMI scanning system may be attached to radiofrequency connector 120 from outside of the target computing system 1200. The feedline has a mating connector that is compatible with connection to radiofrequency connector 120.

In an alternative embodiment, the expansion slots include disk drive slots of a disk drive bay or enclosure, and the antenna expansion card 1005 is configured to engage with and occupy one or more disk drive slots. For example, the frame 505 may be configured to engage with and index position off of one or more latches, rails, releases, drive connectors such as SATA or SAS connectors, walls of the disk drive bay or slot, or other physical features of the disk drive slot. In one embodiment, frame 505 is configured to hold PCB 100 in a middle of the disk drive slot, for example at a plane dividing the volume of the disk dive slot at a center of the shortest (or height) dimension. The antenna expansion card 1005 may be configured to conform with the form factor of the disk drive slot, for example with one of the 2.5-inch, 3.5-inch, or 5.25-inch form factors. Depending on the configuration of the target computing device 1200, installation of the antenna expansion card in the disk drive bay may reduce sensitivity to EMI in comparison with installation in expansion card slots. For example, the expansion card slots are generally more proximate to processors, memory, and other solid state electronic components than are the disk drive slots. The expansion card slots are therefore closer to the widest variety of EMI sources within the chassis than are the disk drive slots, increasing sensitivity to EMI.

### —RF Characteristics of Example Antenna—

As mentioned above, the EMI fingerprinting antenna (e.g., antenna region 110) is a broadband antenna. A broadband antenna operates to receive signals across a broad range of frequencies in a frequency spectrum, for example without significant degradation in performance. The broadband antenna is not specifically configured to operate at an individual frequency. Instead, the broadband antenna has an ability to operate across a wide span of frequencies, ranging from lower to higher frequencies, providing comprehensive coverage across most or all of the frequencies within the range. The broadband antenna supports frequencies across the spectrum of interest, providing relatively consistent performance across different frequencies. For example, in one embodiment, the broadband antenna covers the Ultra High Frequency (UHF) range of radiofrequencies from 300 MHz to 3 GHz. In one embodiment, the broadband antenna covers frequencies from 600 MHz to 3.2 GHZ.

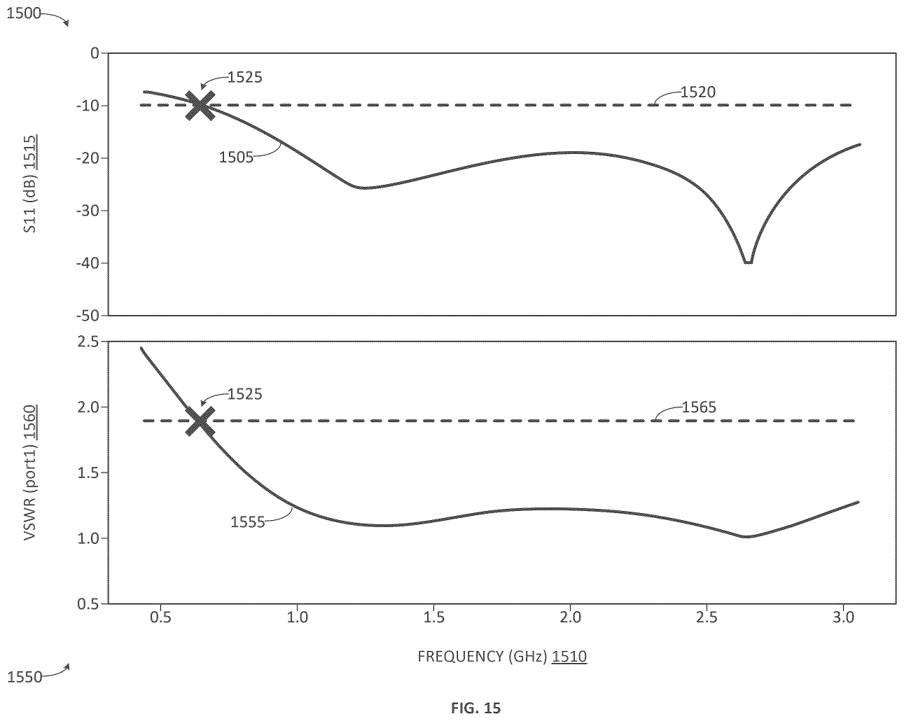

Return Loss (RL) and Voltage Standing Wave Ratio (VSWR) are two parameters used to characterize the performance of antennas. Referring now to FIG. 15, FIG. 15 illustrates a first plot 1500 of return loss 1505 and a second plot 1550 of voltage standing wave ratio 1555 for an example EMI fingerprinting antenna associated with EMI fingerprint characterization of computing systems that is configured as shown and described with reference to FIGS. 1-11. Return loss 1505 of the example EMI fingerprinting antenna is plotted against a frequency axis 1510 and an RL amplitude axis 1515. Voltage standing wave ratio 1555 is plotted against frequency axis 1510 and an VSWR amplitude axis 1560. The RL 1505 and VSWR 1555 for the example EMI fingerprinting antenna are measured across a broad range of frequencies from 0.4 GHz to 3.2 GHZ.

Return loss 1505 is a measure of the amount (that is, amplitude) of power reflected back from the example fingerprinting antenna due to impedance mismatches at a given frequency. Return loss 1505 is expressed in decibels (dB) and is calculated as the ratio of the power of the incident wave to the power of the reflected wave. In general, lower amplitudes of return loss 1505 indicate better impedance matching, less signal loss, and therefore higher sensitivity to RF radiation at a given frequency. For broadband sensitivity, the example EMI fingerprinting antenna exhibits a consistently low return loss of less than −10 dB across a wide frequency range from 0.6 GHz 1525 to 3.2 GHZ (and beyond). In one embodiment, RL loss below −10 dB indicates satisfactory sensitivity for EMI fingerprinting of computing equipment, although higher values for RL loss may also be acceptable, for example RL loss below −5 dB, or even −1 dB.

VSWR 1555 is another measure of impedance matching in the example EMI fingerprinting antenna. VSWR 1555 and quantifies the ratio of the maximum voltage (standing wave) to the minimum voltage from the antenna through the signal lead of RF connector 120 (or along a feedline connected to RF connector 120). In general, lower amplitudes of VSWR 1555 indicates better impedance matching, less signal reflection, and therefore higher sensitivity to RF radiation at a given frequency. For broadband sensitivity, the example EMI fingerprinting antenna exhibits a consistently low VSWR 1555 of less than 1.9:1 across a wide frequency range from 0.6 GHz 1525 to 3.2 GHZ (and beyond). In one embodiment, VSWR below 1.9:1 indicates satisfactory sensitivity for EMI fingerprinting of computing equipment, although higher values for VSWR may also be acceptable, for example VSWR below 2:1, or even 3:1.

In one embodiment, the example EMI fingerprinting antenna (e.g., antenna region 110) has a response that is symmetrical about its own lengthwise, axis, and has a response biased away from the west, exterior end of the expansion card, and toward the east, interior end of the expansion card. Thus, when installed in an expansion slot, the example EMI fingerprinting antenna (e.g., antenna region 110) has a response that is symmetrical about a lengthwise axis of the expansion slot in which it is installed. And, the response is biased toward an interior of the chassis.

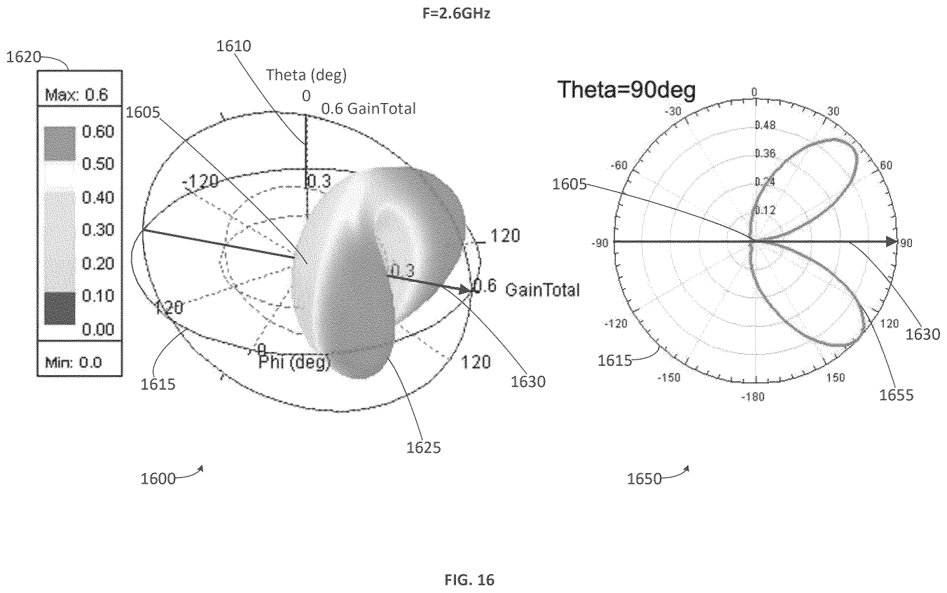

For example, FIG. 16 illustrates a 3D gain plot 1600 and a 2D gain plot 1650 at a frequency of 2.6 GHz for the example EMI fingerprinting antenna associated with EMI fingerprint characterization of computing systems. The origin point 1605 of the gain plots is a point at the vertical center of the transition from a narrow end of a triangular antenna region (such as antenna region 110) and a throat (such as throat 125). In one embodiment, point at the vertical center of the transition is an excitation point of a coplanar waveguide defined by throat 125 and flanking straight edges of ground regions 115a, 115b. A pole 1610 extends vertically (in a north-south orientation) through origin point 1605. A reference plane 1615 extends through origin point 1605 at an angle perpendicular to pole 1610. Reference plane 1615 coincides with a plane of the conductive trace of antenna region 110 and throat 125. For example, reference plane 1615 may be centered laterally within the conductive layer. In 3D gain plot 1600, the radial distance (r) from the origin point is shown by the various shadings given in key 1620. A Y axis 1630 extends through origin point 1605 in reference plane 1615 perpendicularly to pole 1610 (a Z axis) and an X axis in reference plane 1615.

3D gain plot 1600 shows a 3D radiation pattern 1625 for the example EMI fingerprinting antenna at a frequency of 2.6 GHz. 2D gain plot 1650 shows a 2D radiation pattern 1655 in the reference plane 1615 for the example EMI fingerprinting antenna at a frequency of 2.6 GHz. The 3D radiation pattern 1625 and 2D radiation pattern 1655 show that, at 2.6 GHZ, the example EMI fingerprinting antenna has a response that is symmetrical about a Y axis 1630 of the antenna. And, the response prefers the positive direction (which is eastward in the PCB 100, toward the interior of chassis 1205 when installed) from the origin along the Y axis 1630.

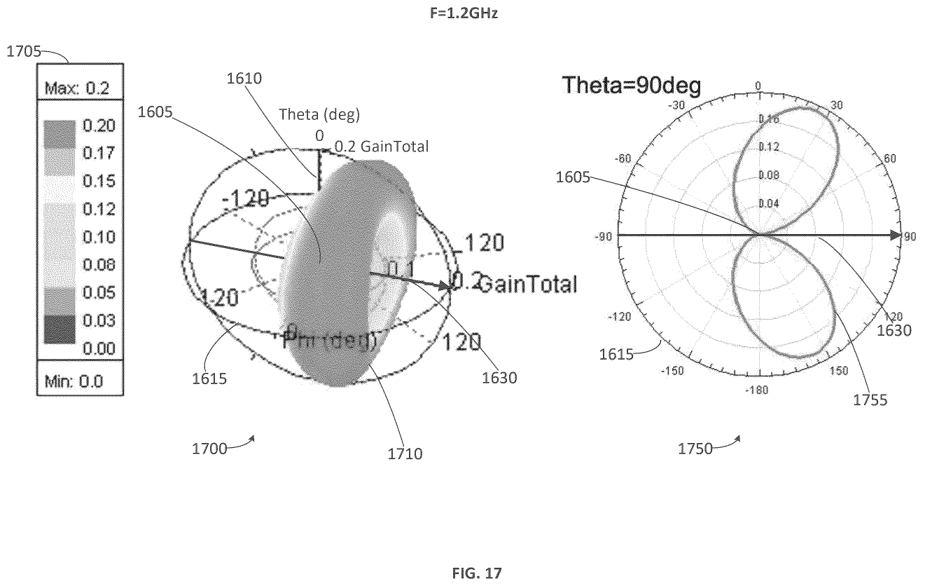

FIG. 17 illustrates a 3D gain plot 1700 and a 2D gain plot 1750 at a frequency of 1.2 GHz for the example EMI fingerprinting antenna associated with EMI fingerprint characterization of computing systems. In 3D gain plot 1700, the radial distance (r) from the origin point is shown by the various shadings given in key 1705. 3D gain plot 1700 shows a 3D radiation pattern 1710 for the example EMI fingerprinting antenna at a frequency of 1.2 GHz. 2D gain plot 1750 shows a 2D radiation pattern 1755 in the reference plane 1615 for the example EMI fingerprinting antenna at a frequency of 1.2 GHz. The 3D radiation pattern 1710 and 2D radiation pattern 1755 show that, at 1.2 GHz as well, the example EMI fingerprinting antenna has a response that is symmetrical about Y axis 1630 of the antenna, with the preference for the positive direction from the origin along the Y axis 1630.

The antenna response that is symmetrical about Y axis 1630, with a preference or bias toward the positive (eastward) direction towards the interior of the chassis 1205 provides reception coverage of the interior of the chassis 1205. To take advantage of this response pattern when collecting EMI within the chassis 1205 of target computer system 1200, in one embodiment, the expansion slot in which the example EMI fingerprinting antenna is installed is closest to a lateral centermost position within the chassis 1205. The lateral center of the chassis 1205 is a plane midway between the side walls of the chassis. For example, the side walls are exterior chassis walls that are substantially perpendicular to I/O wall 1220 and substantially parallel to center 1310 planes of expansion slots 1210.

Or, in another embodiment, the expansion slot in which the example EMI fingerprinting antenna is installed is closest to a signal (EMI) hotspot within the chassis 1205. EMI hotspots in the chassis 1205 can exist due to a variety of causes. For example, EMI hotspots may occur in proximity to high-speed components (e.g. processors, memory modules, or high-speed busses) which generate rapid changes in electric currents and attendant radiofrequency EMI. And, for example, EMI hotspots in the chassis may also be due to resonance effects, in which EMI interacts with structural elements or other electronics within the chassis 1205, amplifying EMI at specific areas. Positions of EMI hotspots within chassis 1205 may be detected by an initial survey (of the target computer system 1200 or of a reference computer system of a type similar to that of target computer system 1200) to find positions at which EMI peaks within the chassis 1205.

—Selected Features of Example Computer with Fingerprinting Antenna Expansion Card—

In one embodiment, in the example target computer system 1200, the broadband antenna has a response that is symmetrical about a lengthwise axis of the expansion slot and biased toward an interior of the chassis.

In one embodiment, in the example target computer system 1200, the expansion slot in which the expansion card 1005 is installed is closest to one of (i) a lateral centermost position within the chassis or (ii) a signal hotspot within the chassis.

In one embodiment, in the example target computer system 1200, the expansion card 1005 is not in electronic communication with the computer system.

As discussed in further detail below with reference to FIG. 18, in one embodiment, the example target computer system 1200 is further includes an EMI scanning system (such as EMI scanning system 1800) that is external to the example target computer system 1200. The EMI scanning system includes a radio receiver that is electrically connected to the broadband antenna, for example through a feedline between the radiofrequency connector and an antenna input of the radio receiver. The radio receiver is configured to output readings of the radiofrequency EMI sensed using the antenna expansion card 1005. The EMI scanning system includes a processor and memory that are communicably coupled to the radio receiver, and which are configured to receive readings of the radiofrequency EMI taken by the radio receiver. The EMI scanning system includes one or more non-transitory computer-readable media including instructions that, when executed by the processor accessing the memory, cause the EMI scanning system to detect that one of the computing components behaves anomalously. The detection is based on a difference between readings of radiofrequency EMI sensed within the computer system by the broadband antenna and machine learning estimates of radiofrequency EMI for a reference computer system. The EMI scanning system includes a display configured to show an indication when the one of the computing components has been detected to behave anonymously.

### Discussion and Further Embodiments

Counterfeit electronic components in international supply chains are a $250B per year problem that exists across industries that use electronics. Although counterfeit components were mostly a costly nuisance for IT systems, it has become a safety-critical issue for military and transportation systems. A US Senate Committee on Armed Services found that over 1-million counterfeit components have been found in all electronic systems in the US DoD. Despite intense efforts to tighten supply-chain checkpoint procedures throughout the world, the problem of counterfeit electronic components continues.

More insidiously, spychips may be surreptitiously incorporated into computer systems or their electronic components. The spychips may enable software/firmware modification, data breaches and exfiltration, unauthorized access or control, malware propagation and persistence, unauthorized surveillance, and espionage. These may result in damage to equipment, economic damage, loss of reputation and trust, and legal and regulatory noncompliance by the owners, operators, or users of the compromised computer systems. Documented cases of spychips discovered in computing equipment are growing in number.

Further, computers and their electronic components can degrade over time and with use due to various factors including physical wear and tear, thermal stress, electrical, stress, and environmental factors. Many failure modes alter the nominal EMI profile of the computers and their components. For example, hardware failure may cause voltage fluctuations or increased electrical noise, thus changing the EMI profile. Or, for example, thermal stress may cause semiconductor junctions to leak current, thus changing the EMI profile. Or, in another example, electrical stress such as voltage fluctuations and power surges may exacerbate electromigration or oxide breakdown, again changing the EMI profile. In yet another example, unanticipated rapid aging of components, such as the development of tin whiskers on solder joints also changes the EMI profile.

Electromagnetic interference (EMI) fingerprinting refers to techniques to identify component configurations of electronic devices based on the unique electromagnetic signals given off by a particular configuration during operation. EMI fingerprinting may be used to (i) detect presence of counterfeit components in electronic systems, (ii) detect presence of SpyChips—devices surreptitiously incorporated into an electronic system to modify software or firmware, exfiltrate data, or perform other malicious activities—in electronic systems, and/or (iii) detect degradation of electronic components over time.

For example, radiofrequency EMI signals—which emanate from all operating electronics—may be captured from a computer system using scanning equipment including an antenna and radio receiver to produce an EMI fingerprint for the computer system. A “Golden System EMI Fingerprint” is created on a reference computer system for which engineers certify there are only authentic internal components (no spychips or counterfeits) in a known state of degradation. A “Target System EMI Fingerprint” is created on a target computer system for which the status of component authenticity and state of degradation may be unknown. The Golden System and Target System EMI Fingerprints are compared to passively detect (i) the presence of internal counterfeit electronic components, SpyChips, or degradation; or (ii) the absence of counterfeits, SpyChips, or degradation.

Thus, radiofrequency antennae are used to gather the EMI of a target computer (or other) system, which may then be analyzed to detect SpyChips (or other modchips), counterfeit component, or the incipience or progression of component degradation. The quality of the EMI Fingerprint is largely dependent on the performance of the antenna in the EMI scanning system. External hand-held wand antennas, magnetic-mount external antennas, and customized server lids that include antennas can work for generation of EMI fingerprints, but these solutions suffer from a number of drawbacks.

Hand-held and magnetic-mount antennas suffer from variability in positions and orientations at which technicians or engineers hold or mount the antennas. For example, a hand-held “wand”-style antenna might be used to pick up EMI signatures to detect the presence of tin whiskers, counterfeit components, developing degradation in solid-state components, or mod/spy chips. However, for EMI fingerprinting of multiple devices, humans who manually scan servers for internal anomalies may exhibit variability in the positions, the orientations, or the distances at which they hold the analysis wand (or affix the mag-mount) relative to the surfaces the server. This process variability affects the rate of false positives, as well as the rate of missed alarms (i.e., Type I and Type II errors).

And, for the large variety of make and model for datacenter, server, and personal computing devices in the world, there are too many variations for engineers to modify a customized server lid to adapt to the geometry changes. For example, a customized server top that has a long antenna affixed to its under-side surface (an “instrumented top”) may be substituted for the original server top during the EMI fingerprinting scan. In experimentation, the original server top may be opened, replaced with the instrumented top, the EMI fingerprinting scan completed, and the original top returned in under 15 minutes. But since the customized server lid is specific to the chassis employed by individual manufacturers, making the instrumented top available to many manufacturers is impracticable.

In one embodiment, a new approach to antennas for EMI fingerprint characterization is presented herein by incorporating a triangular monopole antenna that is customized and optimized for the task of collecting broadband EMI emissions within a computer chassis into an industry-standard expansion card, creating an insertable device that can be easily installed in servers and computers where an expansion slot is available. Expansion slots are generally available in computing devices, for example, PCI slots (and/or their successor PCIe slots) have been standard on motherboards since 1992. Therefore, in one embodiment, the antenna expansion card overcomes the challenges of prior-art EMI Fingerprint characterization of server systems with a novel EMI sensing technique and apparatus. In one embodiment, the antenna described herein is relatively low-cost, uniform, suitable for mass production, removes human variability in the scanning process, and can be applied to modern as well as legacy computing systems throughout the world. Further, in one embodiment, the scan may be accomplished without removing covers or cases, and without disassembling motherboards or other components.

In one embodiment, the antenna expansion card is a universal antenna in compliance with industry standards. In one embodiment, the antenna expansion card is generalizable to any server assets. In one embodiment, the antenna expansion card requires minimal attention, interaction, or training with respect to humans that are conducting the scans. In one embodiment, the antenna expansion card is a standard PCIe device, as PCI/PCIe slots have become standard on motherboards for 30 years. In one embodiment, the antenna expansion card is a triangular monopole antenna in the form factor of a standard low-profile PCIE card. In one embodiment, the antenna expansion card can therefore be inserted into the PCIE slot (or other expansion slot) that is generally available in servers.

Use of the antenna expansion card for EMI fingerprint scanning makes it extremely easy to periodically collect or check the EMI fingerprint of the servers in the supply chain, or at ports of entry, or when servers are received by a datacenter customer as part of initial setup preparation and testing. The repeated testing may be performed to ensure no counterfeits or mod chips are installed anywhere between manufacturing and “assembly” plant, which can be in a different country or in transit between the assembly factory and the customer datacenter.

In experimental testing, the antenna expansion card was used successfully both (i) to detect unwanted electronic components and (ii) to distinguish different server types using two configurations of Oracle® X8-2L servers.

In one embodiment, the PCB fingerprinting antenna and antenna expansion card may be used generally in the application areas for printed circuit boards, including applications in medical devices, industrial equipment, automotive, lighting, LEDs, security applications, communications, computer and servers, home appliances, monitors, navigation, scanning equipment, consumer electronics, transportation and transportation systems, aerospace and space components, marine applications, military and defense appliances and applications, measuring equipment, gaming electronics, recording devices, and other for printed circuit boards. Moreover, the antenna expansion card solution not only applies to legacy server systems, but also applies wherever standardized expansion slots are available in electronic equipment. These expansion slots may vary in dimensions of available card electromechanical volume based on the standard applicable to the expansion slot, but in general, an antenna expansion card as described herein may be configured to conform to the dimensional specifications of the expansion slot. The antenna expansion card therefore finds application for EMI fingerprinting across a wide variety of industries.

For example, telecommunication equipment such as routers as routers, switches, and modems used in telecommunications networks often feature expansion slots to accommodate additional network interface cards (NICs), expansion modules, or interface cards for connecting to different types of networks or adding specialized functionality. And, for example, industrial control systems, including programmable logic controllers (PLCs), distributed control systems (DCS), and supervisory control and data acquisition (SCADA) systems, may incorporate expansion slots to support additional input/output (I/O) modules, communication interfaces, or specialized control modules for interfacing with sensors, actuators, and other industrial equipment. Also, for example, test and measurement instruments such as oscilloscopes, spectrum analyzers, and signal generators often include expansion slots for adding modular measurement modules, interface cards, or specialized analysis tools to extend the capabilities of the instrument or accommodate specific testing requirements. In another example, professional audio and video equipment, including mixers, amplifiers, video routers, and digital signal processors, may feature expansion slots for adding audio interface cards, video processing modules, or networking interfaces to integrate with other equipment or expand the device's functionality. In a further example, medical devices and equipment, such as patient monitors, imaging systems, and diagnostic instruments, may incorporate expansion slots for adding specialized measurement modules, communication interfaces, or data acquisition cards to support specific medical applications or integrate with hospital networks. In yet another example, radar and electronic warfare (EW) systems used in military aircraft, ships, and ground-based installations may incorporate expansion cards to support additional radar modes, signal processing algorithms, or EW techniques.

In one embodiment, the novel and low-cost antenna design shown and described herein overcomes challenges to EMI fingerprint characterization of servers and other electronic equipment for detection of component degradation or of counterfeits, spychips, or other unwanted components; removes human variability in the EMI fingerprint scanning process; and makes EMI fingerprinting generally applicable to any legacy computing systems (or other electronic computer systems) where an expansion slot is available.

In one embodiment, the antenna expansion card integrates a specialized antenna into an expansion card filler module (such as the combination of frame 505 and I/O bracket 905) that complies with an industry standard for the expansion card and can be used as an insertable device. In one embodiment, the antenna expansion card integrates a broadband antenna into a PCIe filler, for example integrating a triangular monopole antenna on a FR4 PCB, a surface mount SMA connector, and a PCIE filler module. In this configuration, the antenna expansion card can be used as an insertable device for modern and legacy enterprise servers. And, in this configuration, experimentation has demonstrated the antenna expansion card to produce high-fidelity EMI fingerprints.

As of 2022, the Federal Acquisition Regulations (FARs) require that all suppliers to any Government agencies certify the absence of Counterfeits and SpyChips. Advantageously, in one embodiment, the antenna expansion card particularly addresses the counterfeit and spychip challenges for all datacenter assets. In conjunction with EMI fingerprinting, the antenna expansion card may be used to passively detect and certify the absence of counterfeits and spychips.

Servers (and other computer systems) contain a variety of electronic components and chips running at different clock speeds. At present, the strongest EMIF signals emitted by the computer systems are in the UHF (300 MHz-3 GHZ) range. Also, the servers have internal protocols for power distribution, so the EMI signal map follows certain time sequencies while executing different commands. In addition, a metal chassis is employed in the computer system to (i) avoid unwanted signal interreference as well as (ii) minimizing radiation outside the servers, in compliance with EMI regulations. Therefore, computer system environment for EMI fingerprinting can be approximated to a resonating metal cavity with multiple sources radiating towards random directions at UHF frequencies, creating local signal hotspots.

In one embodiment, a PCB fingerprinting antenna (e.g., PCB 100) is described herein, for example with reference to FIGS. 1-4. The PCB fingerprinting antenna is a planar triangular monopole antenna (e.g., antenna region 110) with flared ground (e.g., ground regions 115a, 115b). The PCB fingerprinting antenna has a single layer PCB with FR4 as the substrate (dielectric constant ∈=4.5, per manufacturer data). In one embodiment, the PCB fingerprinting antenna measures 60 mm wide by 105 mm long by 1.6 mm thick, for example as shown in FIG. 2.

As shown in FIGS. 1-3, in one embodiment the PCB fingerprinting antenna is configured to have a planar flared monopole configuration. The configuration planar flared monopole configuration enables coverage of as wide bandwidth as possible (at hotspot location selected for testing) within the geometric constraint limited by an express PCI card. The PCIe geometric constraint enables mass-production of the PCB and installation within the volume allotted to a PCIe expansion slot (for example as shown and described with reference to FIGS. 12-14). The monopole ensures omnidirectional collection of radiation pattern (for example as shown with reference to FIGS. 16 and 17). The triangular shape extends the operating bandwidth (here defined by return loss lower than −10 dB, VSWR below 1.9:1) above 600 MHZ (to cover frequencies detected for internal signal maps from testing), with two optimum resonances at 1.2 GHz and 2.6 GHz. The measured data shifts the resonance frequencies to 1.3 GHZ and 2.45 GHZ, which matches the strongest radiation signal from testing. In one embodiment, the PCB fingerprinting antenna is fed by coplanar waveguide excitation (e.g., as shown at throat 125) designed for a standard 50 Ohm end-launch SMA connector. In one embodiment, the grounds are flared with optimized spline curves for wideband impedance matching. In one embodiment, the PCB fingerprinting antenna design is applicable to the geometry of typical servers. In one embodiment, the resonance frequency of the PCB fingerprinting antenna can be readily tuned by multiple geometric parameters. As shown in FIGS. 16 and 17, the gain plots (1600, 1650, 1700, and 1750) of the radiation pattern of the PCB fingerprinting antenna shows that the PCB fingerprinting antenna has symmetrical response about a Y axis (labeled in FIG. 2), with a preference towards a positive direction (away from throat 125).

In one embodiment, the PCB fingerprinting antenna is integrated with a PCIE housing bracket (e.g., I/O bracket 905, for example as shown with reference to FIGS. 9-11). In one embodiment, a low-profile PCIE back cover (e.g., frame 505, for example as shown with reference to FIGS. 5-11) is fastened on the PCB fingerprinting antenna. This assembly of the PCB fingerprinting antenna, housing bracket (frame), and back cover (I/O bracket) forms an antenna expansion card. In one embodiment, the antenna expansion card itself is configured to be installed in a way that provides a clearest EMI signal from the whole server to the PCB fingerprinting antenna. For example, when the antenna expansion card is installed, the PCB fingerprinting antenna is centered in the PCIe volume, to give as much clear space around the antenna elements as possible to reduce the effect of any PCIe cards installed next to the antenna. The antenna expansion card registers on the PCIe slot (e.g., using dummy edge finger 530) to allow for repeatable results with multiple insertions and removals of the card, and to reduce variation in the EMI fingerprint due to shock, vibration, or reinstallation of the antenna. Shock may be due to rough handling during shipping. Vibration may be due to operational vibration of the computer system (including resonant amplification of vibration) which may be caused, for example, by cooling fans. Positioning of the antenna is rendered consistent, rigid, and repeatable after removal and reinstallation by the third point connection of the card to the expansion connector in addition to the two points at the top and bottom of the I/O bracket. Thus, in one embodiment, a triangular monopole antenna is attached onto a PCIe housing bracket.

### —Example EMI Scanning System—

In one embodiment, an EMI scanning system that is external to target computer system 1200 is configured to collect EMI from target computer system 1200 through the broadband antenna expansion card 1005 installed within chassis 1205 of target computer system 1200. FIG. 18 illustrates an example EMI scanning system 1800 associated with specialized antenna for EMI fingerprint characterization of computing systems. In one embodiment, EMI scanning system 1800 includes a radio receiver 1801 electrically connected to the broadband antenna 1802 of antenna expansion card 1005. EMI scanning system 1800 includes a computer 1805, having a processor 1810 and memory operably communicably coupled to the radio receiver. EMI scanning system 1800 includes one or more non-transitory computer-readable media, such as computer-readable media 1837. Computer-readable media 1837 includes computer-executable instructions that, when executed by the processor accessing the memory, cause the EMI scanning system to detect that one of computing components 1803 within the chassis of target computer system 1200 behaves anomalously. The detection of the anomaly is based on a difference between (i) readings of radiofrequency EMI 1804 sensed within target computer system 1200 by broadband antenna 1802 and (ii) machine learning estimates of radiofrequency EMI for a reference computer system. In one embodiment, EMI scanning system 1800 includes a display 1870 that is configured to show an indication when the one of the computing components 1803 has been detected to behave anonymously.

Antenna expansion card 1005 (including broadband antenna 1803) is physically positioned within target computer system 1200 by being installed in an expansion slot of target computer system 1200. Broadband antenna 1802 is thus in position to collect radiofrequency EMI 1804 emitted within the chassis 1205 of computer system 1200, for example, radiofrequency EMI 1804 that is emitted due to operation of computing components 1803 of computer system 1200.

In one embodiment, radio receiver 1801 is configured to receive radiofrequency EMI 1804 picked up by broadband antenna 1802 and convert them to a format readable by computer 1805. In one embodiment, radio receiver 1802 is a software-defined radio (SDR) receiver. For example, radio receiver 1802 has a local oscillator (such as a crystal oscillator) configured to generate stable radiofrequency oscillations for reference in frequency synthesis. Radio receiver 1801 also includes a frequency synthesizer (such as a phase-locked loop frequency synthesizer) configured to generate frequencies from multiples of the oscillations of the local oscillator. Radio receiver 1801 may further include other radio front end hardware components, such as a signal amplifier. In one embodiment, Radio receiver 1801 includes a radiofrequency demodulator. Broadband antenna 1802 is thus communicably coupled to the radiofrequency demodulator, which in one embodiment, operates to extract the sensed EMI.

In one embodiment, radio receiver 1802 is configured to convert radiofrequency EMI 1804 from analog voltage variations induced in the broadband antenna 1803 to a stream of digital amplitude readings of the radiofrequency EMI 1804. The digital stream of amplitude readings is transmitted to computer 605, for example through I/O ports 1820. In one embodiment, the stream of values is sampled by radio receiver 1802 at a sampling frequency that is at least twice the maximum frequency sensed by broadband antenna 1802, so as to effectively record radiofrequency EMI 1804 at the top end of the broadband spectrum of the broadband antenna 1802. For example, where the top of the broadband spectrum sensed by broadband antenna 1802 is 3.2 GHZ, radio receiver 1802 is configured to sample the radiofrequency EMI 1804 at a sampling frequency of 6.4 GHz or more.

In one embodiment, the computer executable instructions implement an expansion card antenna EMI fingerprinting logic 1830. (Logic 1830 is shown in FIG. 18. separately from other CRM 1837, storage 1835, memory 1815 for convenience.) In one embodiment, logic 1830 causes EMI fingerprinting system 1800 to perform an EMI fingerprinting scan of a target computing system using broadband antenna 1802 of antenna expansion card 1005. For example, EMI fingerprinting system 1800 is caused to detect whether one or more of computing components 1803 of target computer system 1200 are behaving anonymously using readings of radiofrequency EMI 1804 sensed by broadband antenna 1802. For example, the system 1800 collects readings of radiofrequency EMI 1804 using radio receiver 1801. The readings may, in one embodiment, be taken while computer system 1200 is executing a pre-determined test pattern of operations.

The EMI fingerprinting system 1800 compares the readings of radiofrequency EMI 1804 with reference readings of a reference computer system. The reference computer system is configured in a similar manner to target computer system 1200. For example, the reference computer system has one or more of the same types of components as compute components 1803, and which are installed in corresponding physical locations within a chassis of the reference computer system. In one embodiment, the reference computer system is a golden sample that is confirmed to be operating in a nominal manner that is undegraded from certain standards, and which is confirmed to be free of spychips and counterfeit components. In one embodiment, the reference readings used in the comparison are recorded while the reference computer system is executing the pre-determined test pattern. In one embodiment, the reference readings used in the comparison are generated by a machine learning model that is trained to generate estimates of the readings produced while the reference computer system is executing the pre-determined test pattern. In one embodiment, the machine learning model is a multivariate state estimation technique model configured to predict amplitude values in a set of frequency bins of the frequency spectrum sensed by broadband antenna 1802.

Where the readings of radiofrequency EMI 1804 with reference readings of the reference computer system differ so much as to satisfy an anomaly test (such as a sequential probability ratio (SPRT) test), the EMI fingerprinting system 1800 detects that one or more of the computing components 1803 is behaving anomalously. EMI fingerprinting system 1800 then generates an electronic alert or message indicating the detection of the anomaly. In one embodiment, the electronic alert is configured to be presented in a user interface on a display 1870. Display 1870 is configured to show an indication when the computing component(s) 1803 have been detected to be behaving anomalously based on radiofrequency EMI 1804. For example, computer 1805 composes a signal indicating the detection of the anomaly and transmits it to display 1870, which in response presents the indication for viewing.

In one embodiment, example EMI scanning system 1800 is implemented using a computing system that is configured and/or programmed as a special purpose computing device(s) with one or more of the example systems and methods described herein, and/or equivalents. The computing system may include a computer 1805 that includes at least one hardware processor 1810, a memory 1815, and input/output ports 1820 operably connected by a bus 1825. In one example, the computer 1805 may include expansion card antenna EMI fingerprinting logic 1830 configured to facilitate EMI fingerprint characterization of a target computing system using a specialized antenna expansion card, similar to the logic for performance of an EMI fingerprinting scan of a target computing system using broadband antenna as discussed above, and to the systems and devices described with reference to FIGS. 1-17.

In different examples, the logic 1830 may be implemented in hardware, one or more non-transitory computer-readable media 1837 with stored instructions, firmware, and/or combinations thereof. While the logic 1830 is illustrated as a hardware component attached to the bus 1825, it is to be appreciated that in other embodiments, the logic 1830 could be implemented in the processor 1810, stored in memory 1815, or stored in disk 1835.

In one embodiment, logic 1830 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate EMI fingerprint characterization of a target computing system using a specialized antenna expansion card. The means may also be implemented as stored computer executable instructions that are presented to computer 1805 as data 1840 that are temporarily stored in memory 1815 and then executed by processor 1810.

Logic 1830 may also provide means (e.g., hardware, non-transitory computer-readable medium that stores executable instructions, firmware) for performing one or more of the disclosed functions and/or combinations of the functions.

Generally describing an example configuration of the computer 1805, the processor 1810 may be a variety of various processors including dual microprocessor and other multi-processor architectures. A memory 1815 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 1835 may be operably connected to the computer 1805 via, for example, an input/output (I/O) interface (e.g., card, device) 1845 and an input/output port 1820 that are controlled by at least an input/output (I/O) controller 1847. The disk 1835 may be, for example, a magnetic disk drive, a solid-state drive, a floppy disk drive, a tape drive, a Zip drive, a flash memory card, a memory stick, and so on. Furthermore, the disk 1835 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 1815 can store a process 1850 and/or a data 1840, for example. The disk 1835 and/or the memory 1815 can store an operating system that controls and allocates resources of the computer 1805.

The computer 1805 may interact with, control, and/or be controlled by input/output (I/O) devices via the input/output (I/O) controller 1847, the I/O interfaces 1845, and the input/output ports 1820. The input/output devices include radio receiver 1801. Input/output devices may include, for example, one or more network devices 1855, displays 1870, printers 1872 (such as inkjet, laser, or 3D printers), audio output devices 1874 (such as speakers or headphones), text input devices 1880 (such as keyboards), cursor control devices 1882 for pointing and selection inputs (such as mice, trackballs, touch screens, joysticks, pointing sticks, electronic styluses, electronic pen tablets), audio input devices 1884 (such as microphones or external audio players), video input devices 1886 (such as video and still cameras, or external video players), image scanners 1888, video cards (not shown), disks 1835, and so on. The input/output ports 1820 may include, for example, serial ports, parallel ports, and USB ports.

The computer 1805 can operate in a network environment and thus may be connected to the network devices 1855 via the I/O interfaces 1845, and/or the I/O ports 1820. Through the network devices 1855, the computer 1805 may interact with a network 1860. Through the network 1860, the computer 1805 may be logically connected to remote computers 1865. In one embodiment, the computer 1805 may be connected to target computer system 1200. Networks with which the computer 1805 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A printed circuit board comprising:
a substrate conforming to dimensional specifications of an expansion card for a computer system;
an antenna region of conductive trace disposed on the substrate, wherein the antenna region is substantially triangular;
a plurality of ground regions of conductive trace disposed on the substrate, wherein the ground regions flank the antenna region on opposite sides, and wherein gaps between the ground regions and the antenna region progressively widen; and
a connector communicably coupled to the antenna region.

2. The printed circuit board of claim 1, wherein the printed circuit board is configured to be installed in an expansion slot of the computer system with the antenna region and ground regions oriented within an interior of a chassis of the computer system and the connector extending to an exterior of the chassis of the computer system.

3. The printed circuit board of claim 1, further comprising:
a nonconductive frame affixed to the substrate,
wherein the nonconductive frame has a dummy edge finger that is configured to mechanically engage with an expansion connector of a computer system, and
wherein the nonconductive frame includes a seating surface configured to offset the substrate towards a center of a volume allotted to an expansion slot of a computer system; and
an I/O bracket attached to the nonconductive frame, wherein the connector extends through an opening in the I/O bracket.

4. The printed circuit board of claim 1, wherein the gaps progressively widen by a spline curvature of inner edges of the ground regions away from outer edges of the triangular antenna region.

5. The printed circuit board of claim 1, wherein the antenna region further comprises a throat of conductive trace disposed on the substrate at a narrow end of the antenna region, wherein the signal contact is electrically connected to the antenna region at the throat.

6. The printed circuit board of claim 1, wherein the connector is a radiofrequency connector including at least a signal contact and a ground contact, wherein the antenna region is electrically connected to the signal contact and the ground regions are electrically connected to the ground contact.

7. The printed circuit board of claim 1, wherein the printed circuit board is a planar monopole antenna that is configured to gather broadband radiofrequency emissions from within an interior of a chassis of a computer system.

8. The printed circuit board of claim 1, wherein the antenna region of conductive trace and the ground regions of conductive trace are plated with gold or palladium.

9. The printed circuit board of claim 1, wherein the substrate has a dielectric constant of less than 5.

10. The printed circuit board of claim 1, wherein the printed circuit board is uncoated.

11. An expansion card, comprising:
a nonconductive frame;
a planar antenna printed in conductive material on a dielectric substrate, wherein the planar antenna is supported by the nonconductive frame;
an I/O bracket affixed to the nonconductive frame; and
a connector communicably coupled to the planar antenna and accessible from an exterior surface of the I/O bracket.

12. The expansion card of claim 11, wherein the nonconductive frame further comprises a dummy edge finger configured for mechanically engaging an expansion connector of a computer system, and wherein the nonconductive frame supports the planar antenna in a location that is offset laterally from the dummy edge finger towards a center of an electromechanical volume allotted to the expansion card.

13. The expansion card of claim 11, wherein the expansion card has a form factor confirming to dimensional specifications of a low-profile PCIe expansion card.

14. The expansion card of claim 11,
wherein the dielectric substrate of the planar antenna and nonconductive frame further comprise holes in a plurality of corners,
wherein pairs of the holes in corresponding corners of the dielectric substrate and the nonconductive frame are aligned; and
wherein the expansion card further comprises push-pin rivets installed though the aligned pairs of holes to affix the planar antenna to the nonconductive frame.

15. The expansion card of claim 10, wherein the connector is a radiofrequency connector, the expansion card further comprising:
a cap for the radiofrequency connector; and
a tether attached at a first end to the cap, and at a second end to the exterior surface of the I/O bracket.

16. A computer system, comprising:
a chassis;
computing components within the chassis that generate EMI when operating;
an expansion slot within the chassis that includes an expansion connector; and
an expansion card installed in the expansion slot, the expansion card comprising:
a nonconductive frame having a dummy edge finger configured to mechanically engage the expansion connector of the expansion slot;
a broadband antenna printed in conductive material on a dielectric substrate, wherein the broadband antenna is held by the nonconductive frame at a lateral center of the expansion slot;
an I/O bracket affixed to the nonconductive frame and to the chassis; and
a radiofrequency connector electrically connected to the broadband antenna and accessible from outside the chassis on an exterior surface of the I/O bracket.

17. The computer system of claim 16, wherein the broadband antenna has a response that is symmetrical about a lengthwise axis of the expansion slot and biased toward an interior of the chassis.

18. The computer system of claim 16, wherein the expansion slot in which the expansion card is installed is closest to one of (i) a lateral centermost position within the chassis or (ii) a signal hotspot within the chassis.

19. The computer system of claim 16, wherein the expansion card is not in electronic communication with the computer system.

20. The computer system of claim 16, further comprising an EMI scanning system external to the computer system, the EMI scanning system comprising:
a radio receiver electrically connected to the broadband antenna;
a processor and memory communicably coupled to the radio receiver;
one or more non-transitory computer-readable media including instructions that, when executed by the processor accessing the memory, cause the EMI scanning system to detect that one of the computing components behaves anomalously based on a difference between readings of radiofrequency EMI sensed within the computer system by the broadband antenna and machine learning estimates of radiofrequency EMI for a reference computer system; and
a display configured to show an indication when the one of the computing components has been detected to behave anonymously.
